(19) United States
(12) Patent Application Publication
(10) Pub. No.: US 2004/0125124 A1
(43) Pub. Date: Jul. 1, 2004

(54) Techniques for constructing and browsing a hierarchical video structure

(76) Inventors: Hyeokman Kim, Seoul (KR); Min Gyo Chung, SungNam City (KR); Sanghoon Sull, Seoul (KR); Sangwook Oh, Jeju-si (KR)

Correspondence Address: Gerald E. Linden, 12925 La Rochelle Cr., Palm Beach Gardens, FL, 33410, US

(21) Appl. No.: 10/368,304

(22) Filed: Feb. 18, 2003

Related U.S. Application Data
(63) Continuation-in-part of application No. 09/911,293, filed on Jul. 23, 2001.
(63) Continuation-in-part of application No. PCT/US01/23631, filed on Jul. 23, 2001.
(60) Provisional application No. 60/221,394, filed on Jul. 24, 2000.
(60) Provisional application No. 60/221,843, filed on Jul. 28, 2000.
(60) Provisional application No. 60/222,373, filed on Jul. 31, 2000.
(60) Provisional application No. 60/271,908, filed on Feb. 27, 2001.
(60) Provisional application No. 60/291,728, filed on May 17, 2001.
(60) Provisional application No. 60/359,567, filed on Feb. 25, 2002.

(51) Int. Cl. G09G 5/00

(52) U.S. Cl. 345/716

(57) ABSTRACT

Techniques for providing an intuitive methodology for a user to control the process of constructing and/or browsing a semantic hierarchy of a video content with a computer controlled graphical user interface by utilizing a tree view of a video, a list view of a current segment, a view of visual rhythm and a view of hierarchical status bar. A graphical user interface (GUI) is used for constructing and browsing a hierarchical video structure. The GUI allows the easier video browsing of the final hierarchical video structure as well as the efficient construction or modeling of the intermediate hierarchies into the final one. The modeling can be done manually, automatically or semi-automatically. Especially during the process of manual or semi-automatic modeling, the convenient GUI increases the speed of the construction process, allowing the quick mechanism for checking the current status of intermediate hierarchies being constructed. The GUI also provides a set of modeling operations that allow the user to manually transform an initial sequential structure or any unwanted hierarchical structure into a desirable hierarchical structure in an instant. The GUI further provides a method for constructing the hierarchical video structure semi-automatically by applying the automatic semantic clustering and the manual modeling operations in any order.

### CROSS-REFERENCE TO RELATED APPLICATIONS

This application is a continuation-in-part of U.S. patent application Ser. No. 09/911,293 filed Jul. 23, 2001, which is a non-provisional of:

provisional application No. 60/221,394 filed Jul. 24, 2000;

provisional application No. 60/221,843 filed Jul. 28, 2000;

provisional application No. 60/222,373 filed Jul. 31, 2000;

provisional application No. 60/271,908 filed Feb. 27, 2001; and

provisional application No. 60/291,728 filed May 17, 2001.

This application is a continuation-in-part of PCT Patent Application No. PCT/US01/23631 filed Jul. 23, 2001 (Published as WO 02/08948, 31 Jan. 2002), which claims priority of the five provisional applications listed above.

This application is a continuation-in-part of U.S. Provisional Application No. 60/359,567 filed Feb. 25, 2002.

### TECHNICAL FIELD OF THE INVENTION

The invention relates to the processing of video signals, and more particularly to techniques for producing and browsing a hierarchical representation of the content of a video stream or file.

### BACKGROUND OF THE INVENTION

Most modern digital video systems operate upon digitized and compressed video information encoded into a “stream” or “bitstream”. Usually, the encoding process converts the video information into a different encoded form (usually a more compact form) than its original uncompressed representation. A video “stream” is an electronic representation of a moving picture image.

One of the more significant and best known video compression standards for encoding streaming video is the MPEG-2 standard, provided by the Moving Picture Experts Group, a working group of the ISO/IEC (International Organization for Standardization/International Engineering Consortium) in charge of the development of international standards for compression, decompression, processing, and coded representation of moving pictures, audio and their combination. The MPEG-2 video compression standard, officially designated ISO/IEC 13818 (currently in 9 parts of which the first three have reached International Standard status), is widely known and employed by those involved in motion video applications.

The ISO (International Organization for Standardization) has offices at 1 rue de Varembe, Case postale 56, CH-1211 Geneva 20, Switzerland. The IEC (International Engineering Consortium) has offices at 549 West Randolph Street, Suite 600, Chicago, Ill. 60661-2208 USA.

The MPEG-2 video compression standard achieves high data compression ratios by producing information for a full frame video image only every so often. These full-frame images, or “intracoded” frames (pictures) are referred to as “I-frames”, each I-frame containing a complete description of a single video frame (image or picture) independent of any other frame. These “I-frame” images act as “anchor frames” (sometimes referred to as “key frames” or “reference frames”) that serve as reference images within an MPEG-2 stream. Between the I-frames, delta-coding, motion compensation, and a variety of interpolative/predictive techniques are used to produce intervening frames. “Inter-coded” B-frames (bidirectionally-coded frames) and P-frames (predictive-coded frames) are examples of such “in-between” frames encoded between the I-frames, storing only information about differences between the intervening frames they represent with respect to the I-frames (reference frames).

The Advanced Television Systems Committee (ATSC) is an international, non-profit organization developing voluntary standards for digital television (TV) including digital high definition television (HDTV) and standard definition television (SDTV). The ATSC digital TV standard, Revision B (ATSC Standard A/53B) defines a standard for digital video based on MPEG-2 encoding, and allows video frames as large as 1920×1080 pixels/pels (2,073,600 pixels) at 20 Mbps, for example. The Digital Video Broadcasting Project (DVB—an industry-led consortium of over 300 broadcasters, manufacturers, network operators, software developers, regulatory bodies and others in over 35 countries) provides a similar international standard for digital TV. Real-time decoding of the large amounts of encoded digital data conveyed in digital television broadcasts requires considerable computational power. Typically, set-top boxes (STBs) and other consumer digital video devices such as personal video recorders (PVRs) accomplish such real-time decoding by employing dedicated hardware (e.g., dedicated MPEG-2 decoder chip or specialty decoding processor) for MPEG-2 decoding.

Multimedia information systems include vast amounts of video, audio, animation, and graphics information. In order to manage all this information efficiently, it is necessary to organize the information into a usable format. Most structured videos, such as news and documentaries, include repeating shots of the same person or the same setting, which often convey information about the semantic structure of the video. In organizing video information, it is advantageous if this semantic structure is captured in a form which is meaningful to a user. One useful approach is to represent the content of the video in a tree-structured hierarchy, where such a hierarchy is a multi-level abstraction of the video content. This hierarchical form of representation simplifies and facilitates video browsing, summary and retrieval by making it easier for a user to quickly understand the organization of the video.

As used herein, the term “semantic” refers to the meaning of shots, segments, etc., in a video stream, as opposed to their mere temporal organization. The object of identifying “semantic boundaries” within a video stream or segment is to break a video down into smaller units at boundaries that make sense in the context of the content of the video stream.

A hierarchical structure for a video stream can be produced by first identifying a semantic unit called a video segment. A video segment is a structural unit comprising a set of video frames. Any segment may further comprise a plurality of video sub-segments (subsets of the video frames of the video segment). That is, the larger video segment contains smaller video sub-segments that are related in (video) time and (video) space to convey a certain semantic meaning. The video segments can be organized into a hierarchical structure having a single “root” video segment, and video sub-segments within the root segment. Each video sub-segment may in turn have video sub-sub-segments, etc. The process of organizing a plurality of video segments of a video stream into a multi-level hierarchical structure is known as “modeling” of the content of the video stream, or just video modeling.

A “granule” of the video segment (i.e., the smallest resolvable element of a video segment) can be defined to be anything from a single frame up to the entire set of frames in a video stream. For many applications, however, one practical granule is a shot. A shot is an unbroken sequence of frames recorded by a single camera, and is often defined as a by-product of editing or producing a video. A shot is not implicitly/necessarily a semantic unit meaningful to a human observer, but may be no more than a unit of editing. A set of shots often conveys a certain semantic meaning.

By way of example, a video segment of a dialogue between two actors might alternate between three sets of “shots”: one set of shots generally showing one of the actors from a particular camera angle, a second set of shots generally showing the other actor from another camera angle, and a third set of shots showing both actors at once from a third camera angle. The entire video segment is recorded simultaneously from all three camera angles, but the video editing process breaks up the video recorded by each camera into a set of interleaved shots, with the video segment switching shots as each of the two actors speaks. Taken in isolation, any individual shot might not be particularly meaningful, but taken collectively, the shots convey semantic meaning.

Several techniques for automatic detection of “shots” in a video stream are known in the art. Among others, a method based on visual rhythm, which was proposed by in an article entitled “Processing of partial video data for detection of wipes”, by H. Kim, et al. Proc. of Storage and retrieval for image and video database VII, SPIE Vol.3656, January 1999 and in an article entitled “Visual rhythm and shot verification”, by H. Kim, et al. Multimedia Tools and Applications, Kluwer Academic Publishers, Vol.15, No.3 (2001), is one of the most efficient shot boundary detection techniques. See also Korea Patent Application No. KR 10-0313713, filed December 1998.

Visual rhythm is a technique wherein a two-dimensional image representing a motion video stream is constructed. A video stream is essentially a temporal sequence of two-dimensional images, the temporal sequence providing an additional dimension—time. The visual image methodology uses selected pixel values from each frame (usually values along a horizontal, vertical or diagonal line in the frame) as line images, stacking line images from subsequent frames alongside one another to produce a two-dimensional representation of a motion video sequence. The resultant image exhibits distinctive patterns—the “visual rhythm” of the video sequence—for many types of video editing effects, especially for all wipe-like effects which manifest themselves as readily distinguishable lines or curves, permitting relatively easy verification of automatically detected shots by a human operator (to identify and correct false and/or missing shot transitions) without actually playing the whole video sequence. Visual rhythm also contains visual features that facilitate identification of many different types of video effects (e.g., cuts, wipes, dissolves, etc.).

In creating a multi-level tree hierarchy for a video stream, a first step is detecting the shots of the video stream and organizing them into a single video segment comprising all of the detected shots. The detection and identification of shot boundaries in a video stream implicitly applies a sequential structure to the content of the video stream, effectively yielding a two-level tree hierarchy with a “root” video segment comprising all of the shots in the video stream at a top level of the hierarchy, and the shots themselves comprising video sub-segments at a second, lower level of the hierarchy. From this initial two-level hierarchy, a multi-level hierarchical tree can be produced by iteratively applying the top-down or bottom-up methods described hereinabove. Since the current state-of-the-art video analysis techniques (shot detection, hierarchical processing, etc.) are not capable of automated, hierarchical semantic analysis of sets of shots, considerable human assistance is necessary in the process of video modeling.

A tree hierarchy can be constructed by either top-down or bottom-up methods. The bottom-up method begins by identifying shot boundaries, then clusters similar shots into segments, then finally assembles related segments into still larger segments. By way of contrast, the top-down method first divides a whole video segment into the multiple smaller segments. Next, each smaller segment is broken into still smaller segments. Finally, each segment is subdivided into a set of shots. Evidently, the bottom-up and top-down methods work in opposite directions. Each method has its own strengths and weaknesses. For either method, the technique used to identify the shots in a video stream is a crucial component of the process of building a multi-level hierarchical structure.

A variety of techniques are known in the art for producing a hierarchy for a video stream based upon a set of detected shots. Most of these methods are fully automatic, but provide poor-quality results from a semantic point of view, since the organization of shots into semantically meaningful video segments and sub-segments requires the semantic knowledge of a human. Therefore, to obtain a semantically useful and meaningful hierarchy, a semi-automatic technique that employs considerable human intervention is required. One such semi-automatic method, referred to herein as the “step-based approach”, is described in U.S. Pat. No. 6,278,446, issued to Liou et. al., entitled “System for interactive organization and browsing of video”, incorporated by reference herein (hereinafter “Liou”).

As the multi-level hierarchy is “built” by some prior-art techniques, the hierarchical structure is graphically illustrated on a computer screen in the form of a “tree view” with segment titles and key frames visible, as well as a “list view” of a current segment of interest with key frames of sub-segments visible. In the GUI (Graphical User Interface) of the Microsoft Windows™ operating system, these “tree view” and “list view” displays usually take the form of conventional folder hierarchies used to represent a hierarchical directory structure. In Microsoft Windows Explorer™, the tree view of a file system shows a hierarchical structure of folders with their names, and the list view of a current folder shows a list of nested folders and files within the current folder. Similarly, in the conventional graphical illustration of hierarchical video structure, the tree view of a video shows a hierarchical structure of video segments with their titles and key frames, and the list view of a current segment shows a list of key frames representing the sub-segments of the current segment.

Although the conventional display of a video hierarchy may be useful for viewing the overall structure of a hierarchy, it is not particularly useful or helpful to a human operator in analyzing video content, since the “tree view” and “list view” display formats are good at displaying the organizational structure of a hierarchy, but do little or nothing to convey any information about the information content within the structure of the hierarchy. Any item (key frame, segment, etc.) in a list view/tree view can be selected and played back/displayed, but the hierarchical view itself contains no useful clues as to the content of the items. These graphical representation techniques do not provide an efficient way for quickly viewing or analyzing video content, segment by segment, along a sequential video structure. Since the most viable, available mechanism for determining the content of such a graphically displayed video hierarchy is playback, the process of examining a complete video stream for content can be very time consuming, often requiring repeated playback of many video segments.

As described hereinabove, a video hierarchy is produced from a set of automatically detected shots. If the automatic shot detection mechanism were capable of accurately detecting all shot boundaries without any falsely detected or missing shots, there would be no need for verification. However, current state-of-the-art automatic shot detection techniques do not provide such accuracy, and must be verified. For example, if a shot boundary between two shots showing significant semantic change remains undetected, it is possible that the resulting hierarchy is missing a crucial event within the video stream, and one or more semantic boundaries (e.g., scene changes) may be mis-represented by the hierarchy.

Further, the use of familiar “tree view” and “list view” graphical representations does little to provide an efficient way for users to quickly locate or return to a specific video segment or shot of interest (browsing the hierarchy). Moreover, during manual or semi-automatic production of a video hierarchy, users are responsible for identifying separate semantic units (semantically connected sets of shots/segments). Absent an efficient means of browsing, such identification of semantic units can be very difficult and time consuming.

The step-based approach as described in Liou provides a “browser interface” which is a composite image produced by including a horizontal and a vertical slice of a single pixel width from the center line from each frame of the video stream, in a manner similar to that used to produce a visual rhythm. The “browser interface” makes automatically detected shot boundaries (detected by an automatic “cut” detection technique) visually easier to detect, providing an efficient way for users to quickly verify the results of automatic cut detection without playback. The “browser interface” of Liou can be considered a special case of visual rhythm. Although this browser interface mechanism greatly improves browsing of a video, many of the more “conventional” graphical representation used by the step-based method still present a number of problems.

The step-based approach of Liou is based on the assumption that similar repeating shots that alternate or interleave with other shots, are often used to convey parallel events in a scene or to signal the beginning of a semantically meaningful unit. It is generally true, for example, that a segment of a news program often has an anchorperson shot appearing before each news item. However, at a higher semantic level (than news item level), there are problems with this assumption. For example, a typical CNN news program may comprise a plurality of story units each of which further comprises several news items: “Top stories”, “2 minute report”, “Dollars and Sense”, “Sports”, “Life and style”, etc. (It is acknowledged that CNN, and the titles of the various story units, may be trademarks.) Typically, each story unit has its own leading title segment that lasts just a few seconds, but signals the beginning of the higher semantic unit, the story unit. Since these leading title segments are usually unique to each story unit, they are unlikely to appear similar to one another. Furthermore, a different anchorperson might be used for some of the story units. For example, one anchor anchorperson might be used for “Top stories”, “Dollars and Sense”, and “Sports”, and another anchorperson for “2 minute report” and “Life and Style”. This results in a shot organization that frustrates the assumptions made by the step-based approach.

The video structure described hereinabove with respect to a news broadcast is typical of a wide variety of structured videos such as news, educational video, documentaries, etc. In order to produce a semantically meaningful video hierarchy, it is necessary to define the higher level story units of these videos by manually searching for leading title segments among the detected shots, then automatically clustering the shots within each news item within the story unit using the recurring anchorperson shots. However, the step-based approach of Liou permits manual clustering and/or correction only after its automatic clustering method (“shot grouping”) has been applied.

Further, the step-based approach of Liou provides for the application of three major manual processes, including: correcting the results of shot detection, correcting the results of “shot grouping” and correcting the results of “video table of contents creation” (VTOC creation). These three manual processes correspond to three automatic processes for shot detection, shot grouping and video table of contents creation. The three automatic processes save their results into three respective structures called “shot-list”, “merge-list” and “tree-list”. At any point in the process of producing a video hierarchy, the graphical user interfaces and processes provided by the step-based approach can only be started if the aforementioned automatically-generated structures are present. For example, the “shot-list” is required to start correcting results of shot detection with the “browser interface”, and the “merge-list” is needed to start correcting results of shot grouping with the “tree view” interface. Therefore, until automated shot grouping has been completed, the step-based method cannot access the “tree view” interface to manually edit the hierarchy with the “tree view” interface.

Evidently, the step-based approach of Liou is intended to manually restructure or edit a video hierarchy resulting from automated shot grouping and/or video table of contents creation. The step-based approach is not particularly well-suited to the manual construction of a video hierarchy from a set of detected shots.

When a human operator regularly indexes video streams having the same or similar structure (e.g., daily CNN news broadcasts), the operator develops a priori knowledge of the semantic structure and temporal organization of semantic units within those video streams. For such an operator, it is a relatively simple matter to define the semantic hierarchy of a video manually, using only detected shots and a visual interface such as the “browser interface” of Liou or visual rhythm. Often manual generation of a video hierarchy in this manner takes less time than the time to manually correct bad results of automatic shot grouping and video table of contents creation. However, the step-based approach of Liou does not provide for manual generation of a video hierarchy from a set of detected shots.

The “browser interface” provided by the step-based approach can be used as a rough visual time scale, but there may be considerable temporal distortion in the visual time scale when the original video source is encoded in a variable frame rate encoding schemes such as Microsoft's ASF (Advanced Streaming Format). Variable frame rate encoding schemes dynamically adjust the frame rate while encoding a video source in order to produce a video stream with a constant bit rate. As a result, within a single ASF-encoded video stream (or other variable frame rate encoded stream), the frame rate might be different from segment-to-segment or from shot-to-shot. This produces considerable distortion in the time scale of the “browser interface”.

FIG. 1 shows two “browser interfaces”, a first browser interface 102 and a second browser interface 104, both produced from different versions of a single video source, encoded at high and low bit rates, respectively. The first and second browser interfaces 102 and 104 are intentionally juxtaposed to facilitate direct visual comparison. The first browser interface 102 is produced from the video source encoded at a relatively high bit rate (e.g., 300 Kbps in ASF) format, while the second browser interface 104 is produced from exactly the same video source encoded at a relatively lower bit rate (e.g., 36 Kbps). The widths of the browser interfaces 102 and 104 have been adjusted to be the same. Two video “shots” 106 and 110 are identified in the first browser interface 102. Two shots 108 and 112 in the second browser interface are also identified. The shots 106 and 108 correspond to the same video content at a first point in the video stream, and the shots 110 and 112 correspond to the same video content at a second point in the video stream.

In FIG. 1, the widths of the shots 106 and 108 (produced from the same source video information) are different. The different widths of the shots 106 and 108 mean that the frame rates of their corresponding shots in the high and low bit rate encoded video streams are different, because each vertical line of the “browser interface” corresponds to one frame of encoded video source. Similarly, the differing horizontal position and widths of shots 110 and 112 indicate differences in frame rate between the high and low bit-rate encoded video streams. As FIG. 1 illustrates, although the browser interface can be used as a time scale for the video it represents, it is only a coarse representation of absolute time because variable frame rates affect the widths and positions of visual features of the browser interface.

In summary, then, while prior-art techniques for producing video hierarchies provide some useful features, their “conventional” graphical representations of hierarchical structure, (including those of the step-based approach of Liou) do not provide an effective or intuitive representation of nested relationship of video segments, their relative temporal positions or their durations. Semiautomatic methods such as the step-based approach of Liou for producing video hierarchies assume the presence of similar repeating shots, an assumption that is not valid for many types of video. Further, the step-based approach of Liou does not permit manual shot grouping prior to automatic shot grouping, nor does it permit manual generation of a hierarchy.

### BRIEF DESCRIPTION (SUMMARY) OF THE INVENTION

Therefore, there is a need for a method and system that will enable the browsing and constructing of the tree-structured hierarchy of a video content with an effective visual interface in any combination of applying automatic and manual works.

It is a general object of the invention to provide an improved technique for indexing and browsing a hierarchical video structure.

According to the invention, techniques are provided for constructing and browsing a multi-level tree-structured hierarchy of a video content from a given list of detected shots, that is, a sequential structure of the video. The invention overcomes the above-identified problems as well as other shortcomings and deficiencies of existing technologies by providing a “smart” graphical user interface (GUI) and a semi-automatic video modeling process.

The GUI supports the effective and efficient construction and browsing of the complex hierarchy of a video content interactively with the user. The GUI simultaneously shows/visualizes the status of three major components: a content hierarchy, a segment (sub-hierarchy) of current interest, and a visual overview of a sequential content structure. Through the GUI showing the status of the content hierarchy, a user is able to see the current graphical tree structure of a video being built. The user also can visually check the content of the segment of current interest as well as the contents of its sub-segments. The visual overview of a sequential content structure, specifically referring to visual rhythm, is a visual pattern of the sequential structure of the whole content that can visually provide both shot contents and positional information of shot boundaries. The visual overview also provides exact time scale information implicitly through the widths of the visual pattern. The visual overview is used for quickly verifying the video content, segment by segment, without repeatedly playing each segment. The visual overview is also used for finding a specific part of interest or identifying separate semantic units in order to define segments and their sub-segments by quickly skimming through the video content without playback. Collectively, the visual overview helps users to have a conceptual (semantic) view of the video content very fast.

The present invention also provides two more components: a view of hierarchical status bar and a list view of key frame search for displaying content-based key frame search results. The present invention provides an exemplary GUI screen that incorporates these five components that are tightly synchronized when being displayed. The hierarchical status bar is adapted for displaying visual representation of nested relationship of video segments and their relative temporal positions and durations. It effectively gives users an intuitive representation of nested structure and related temporal information of video segments. The present invention also adopts the content-based image search into the process of hierarchical tree construction. The image search by a user-selected key frame is used for clustering segments. The five components are tightly inter-related and synchronized in terms of event handling and operations. Together they offer an integrated framework for selecting key frames, adding textual annotations, and modeling or structuring a large video stream.

The present invention further provides a set of operations, called “modeling operations”, to manipulate the hierarchical structure of the video content. With a proper combination of the modeling operations, one can transform an initial sequential structure or any unwanted hierarchical structure into a desirable hierarchical structure in an instant. With the modeling operations, one can systematically construct the desired hierarchical structure semi-automatically or even manually. Moreover, in the present invention, the shape and depth of the video hierarchy are not restricted, but only subject to the semantic complexity of the video. The routines corresponding to modeling operations is triggered automatically or manually from the GUI screen of the present invention.

In yet another embodiment, the present invention provides a method for constructing the hierarchy semi-automatically using semantic clustering. The method preferably includes a process that can be performed in a combined fashion of manual and automatic work. Before the semantic clustering, a segment in the current hierarchy being constructed can be specified as a clustering range. If the range is not specified, a root segment representing the whole video is used by default. In the semantic clustering, at first, a shot that occurs repetitively and has significant semantic content is selected from a list of detected shots of a video within a clustering range. For example, an anchorperson shot usually occurs at the beginning of each news items in a news video, thus being a good candidate. Then, with a key frame of the selected shot as a query frame, for example, an anchorperson frame of the selected anchorperson shot as a query frame, a content-based image search algorithm is run to search for all shots having key frames similar to the query frame in the list of detected shots within the range. The resulting retrieved shots are listed in the temporal order. With the temporally ordered list of the retrieved shots, shot groupings are performed for each subset of temporally consecutive shots between a pair of two adjacent retrieved shots. After the semantic clustering, the segment specified as a clustering range contains as many sub-segments as the number of shots in the list of the retrieved shots. The semantic clustering can be selectively applied to any segment in the current hierarchy being constructed. Thus, with help of the GUI screen in the present invention, the semantic clustering can be interleaved with any modeling operation. With repeated applications of the modeling operations and the semantic clustering in any combination, the given initial two-level hierarchy can then be transformed into a desired one according to human understanding of the semantic structure. The method will greatly save time and effort of a user.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawings. The drawings are intended to be illustrative, not limiting, and it should be understood that it is not intended to limit the invention to the illustrated embodiments. The Figures (FIGs) are as follows:

FIG. 1 is a graphic representation illustrating of two “browser interfaces” produced from a single video source, but encoded at different bit rates, according to the prior art.

FIGS. 2A and 2B are diagrams illustrating an overview of the video modeling process of the present invention.

FIG. 3 is a screen image illustrating an example of a conventional GUI screen for browsing a hierarchical structure of video content, according to the invention.

FIG. 4 is a diagram illustrating the relationship between three internal major components, a unified interaction module, and the GUI screen of FIG. 3, according to the invention.

FIG. 5 is a screen image illustrating an example of a GUI screen for browsing and modeling a hierarchical structure of video content having been constructed or being constructed, according to an embodiment of the present invention.

FIG. 6 is a screen image of a GUI tree view for a video, according to an embodiment of the present invention.

FIG. 7 is a representation of a small portion of a visual rhythm made from an actual video file with an upper-left-to-lower-right diagonal sampling strategy.

FIGS. 8A and 8B are illustrations of two examples of a GUI for the view of visual rhythm, according to an embodiment of the invention.

FIG. 9 is an illustration of an exemplary GUI for the view of hierarchical status bar, according to an embodiment of the invention.

FIGS. 10A and 10B are illustrations of two unified GUI screens, according to an embodiment of the present invention.

FIGS. 11A-11D are diagrams illustrating the four modeling operations (except the ‘change key frame’ operation), according to an embodiment of the present invention.

FIGS. 12A-12C are diagrams illustrating an example of the semi-automatic video modeling in which manual editing of a hierarchy follows after automatic clustering according to an embodiment of the present invention.

FIGS. 13A-13D are diagrams illustrating another example of the semi-automatic video modeling in which defining story units is manually done first, and then automatic clustering and manual editing of a hierarchy follows in sequence according to an embodiment of the present invention.

FIGS. 14A-14C are flow charts illustrating is an exemplary flowchart illustrating the overall method of constructing a semantic structure for a video, using the abundant, high-level interfaces and functionalities introduced by the invention.

FIGS. 15 (A and B) are illustrations of a TOC (Table-of-Contents) tree template, and TOC tree constructed from the template, according to the invention.

FIG. 16 is an illustration of splitting the view of visual rhythm, according to the invention.

FIG. 17 is a schematic illustration depicting the method to tackle the memory exceeding problem of lengthy visual rhythm while displaying it in the view of visual rhythm, according to the invention.

FIG. 18(A)-(F) are diagrams illustrating some examples of sampling paths drawn over a video frame, for generating visual rhythms, according to the invention.

FIG. 19 is an illustration of an agile way to display a plethora of images quickly and efficiently in the list view of a current segment, according to the invention.

FIG. 20 is an illustration of one aspect of the present invention to cope with situations, where a video segment seems to be visually homogeneous but conveys semantically different subjects, in order to manually make a new shot from the starting point of the subject change, according to the invention.

FIG. 21 is a collection of line drawing images, according to the prior art.

FIG. 22 is a diagram showing a portion of a visual rhythm image, according to the prior art.

### DETAILED DESCRIPTION OF THE INVENTION

The following description includes preferred, as well as alternate embodiments of the invention. The description is divided into sections, with section headings which are provided merely as a convenience to the reader. It is specifically intended that the section headings not be considered to be limiting, in any way. The section headings are, as follows:

1. Tree-Structured Hierarchy of Video Content

Video Modeling

Conventional GUI for Browsing Hierarchical Video Structure

2. GUI for Constructing and Browsing Hierarchical Video Structure

GUI for the Tree View of a Video

GUI for the List View of a Current Segment

GUI for the View of Visual Rhythm

GUI for the View of Hierarchical Status Bar

GUI for the List View of Key frame Search

Unified Interactions between the GUIs

3. Semi-Automatic Video Modeling

Syntactic and Semantic Clustering

Modeling Operations

GUI for Modeling Operations

Integrated Process of Semi-Automatic Video Modeling

4. Extensible Features

Use of Templates

Visual Rhythm Behaves As a Progress Bar

Splitting of Visual Rhythm

Visual Rhythm for a Large File

Visual Rhythm: Sampling Pattern

Fast Display of a Plethora of Key frames

Tracking of the Currently Playing Frame

In the description that follows, various embodiments of the invention are described largely in the context of a familiar user interface, such as the Windows™ operating system and graphic user interface (GUI) environment. It should be understood that although certain operations, such as clicking on a button, selecting a group of items, drag-and-drop and the like, are described in the context of using a graphical input device, such as a mouse, it is within the scope of the invention that other suitable input devices, such as keyboard, tablets, and the like, could alternatively be used to perform the described functions. Also, where certain items are described as being highlighted or marked, so as to be visually distinctive from other (typically similar) items in the graphical interface, that any suitable means of highlighting or marking the items can be employed, and that any and all such alternatives are within the intended scope of the invention.

1. Tree-Structured Hierarchy of Video Content

A multi-level, tree-structured hierarchy can be particularly advantageous for representing semantic content within a video stream (video content), since the levels of the hierarchy can be used to represent logical (semantic) groupings of shots, scenes, etc., that closely model the actual semantic organization of the video stream. For example, an entry at a “root” level of the hierarchy would represent the totality of the information (shots) in the video stream. At the next level down, “branches” off of the root level can be used to represent major semantic divisions in the video stream. For example, second-level branches associated with a news broadcast might represent headlines, world events, national events, local news, sports, weather, etc. Third-level (third-tier) branches off of the second-level branches might represent individual news items within the major topical groupings. “Leaves” at the lowest level of the hierarchy would index the shots that actually make up the video stream.

As a matter of representational convenience, nodes of a hierarchy are often referred to in terms of family relationships. That is, a first node at a hierarchical level above a second node is often referred to as a “parent” node of the second node. Conversely, the second node is a “child” node of the first node. Extending this analogy, further family relationships are often used. Two child nodes of the same parent node are sometimes referred to as “sibling” nodes. The parent node of a child node's parent node is sometimes referred to as the child node's “grandparent” node, etc. Although much less common, this family analogy is occasionally extended to include such extended family relationships as “cousin” nodes (children of sibling parents), etc.

Video Modeling

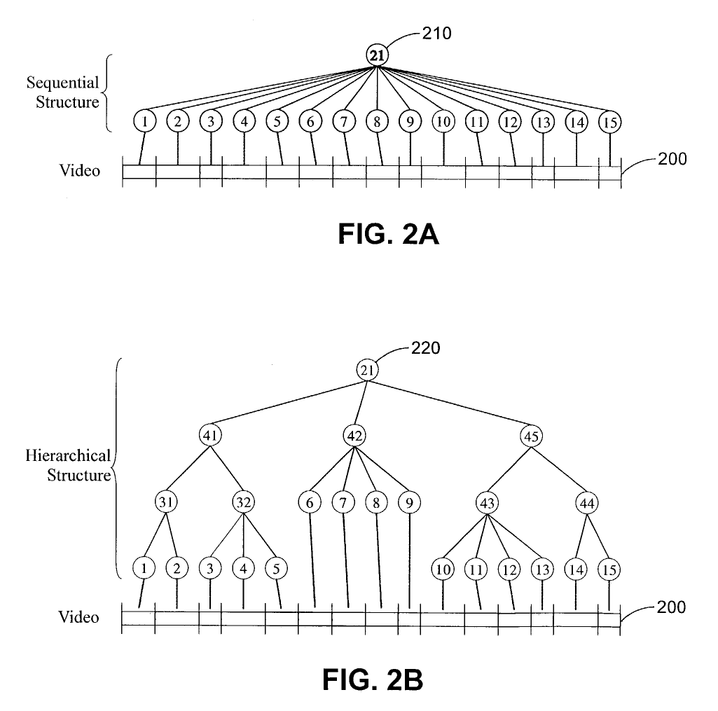

FIGS. 2A and 2B provide an overview of a video modeling aspect of the present invention. An exemplary video stream (or video file) 200 used in the figures consists of fifteen video segments 1-15, each of which is a shot detected by a suitable automatic shot detection algorithm, such as, but not limited to, those described in Liou, or in the aforementioned U.S. patent application Ser. No. 09/911,293. The process of video modeling produces a tree-structured video hierarchy, beginning with a simple two-level hierarchy, then further decomposing the video stream (or file) into segments, sub-segments, etc., in an appropriately structured multi-level video hierarchy.

FIG. 2A is a graphical representation of an initial two-level hierarchy 210 produced by creating a root segment (representing the entire content of the video stream) at a first hierarchical level that references the fifteen automatically detected shots (segments) of the video stream (in order) at a second hierarchical level. The second hierarchical level contains an entry for each of the automatically detected shots as sub-segments of the root segment. In the hierarchy, nodes labeled from 1 to 15 represent the fifteen video segments or shots of the video stream 200 respectively, and the node labeled 21 represents the entire video. In effect, the hierarchy 210 represents sequential organization of the automatically detected shots of the video stream 200 represented as a two-level tree hierarchy.

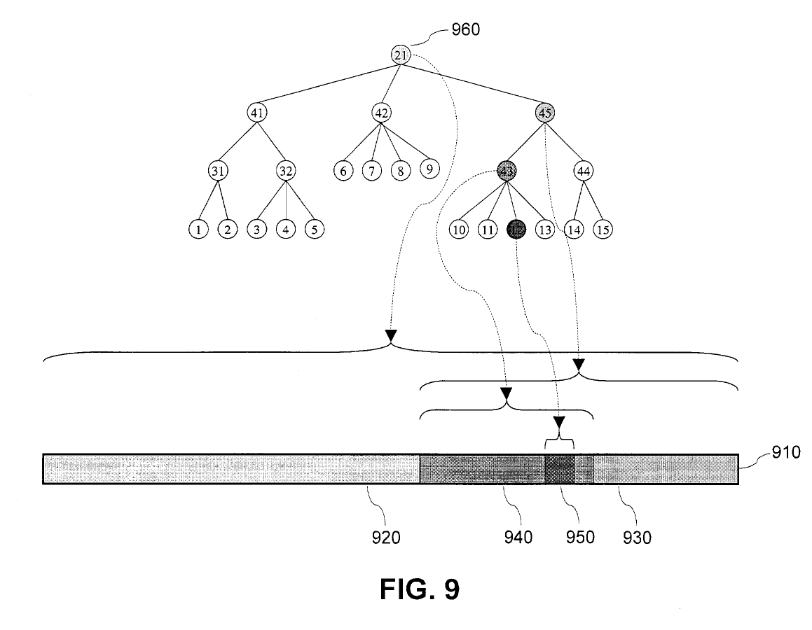

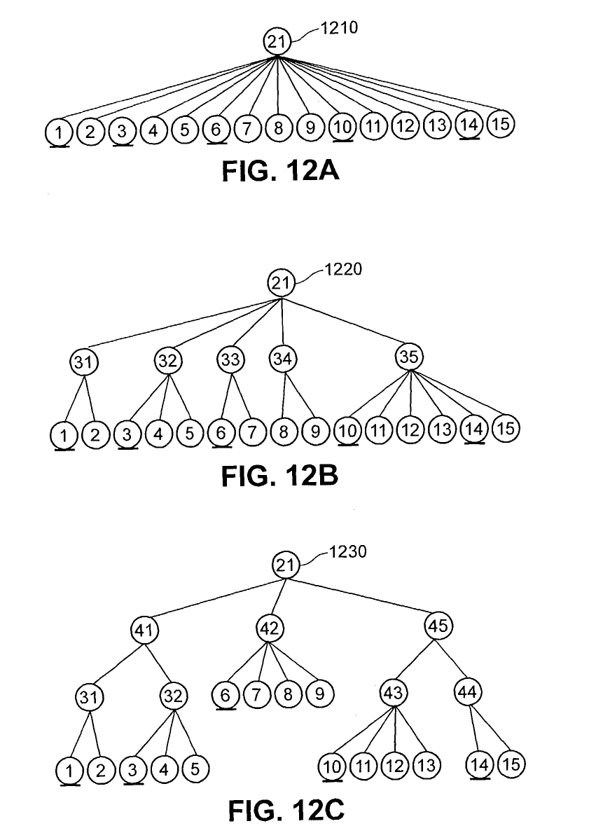

FIG. 2B is a graphical representation of a four-level tree hierarchy 220 that models a semantic structure for the video stream 200 resulting from modeling of the video stream 200. (This exemplary hierarchy will also appear in FIGS. 9 and 12C, described hereinbelow.) In the four-level hierarchy 220, the node 21 representing the entire content of the video stream 200 is subdivided into three major video segments, represented by second level nodes 41, 42 and 45. The video segment represented by the second-level node 41 is further subdivided into two video sub-segments represented by third-level nodes 31 and 32. The video segment represented by the second-level node 45 is further divided into two video sub-segments represented by third-level nodes 43 and 44 respectively. The video sub-segment represented by the third level node 31 is further subdivided into two shots represented by fourth-level nodes 1 and 2. The video sub-segment represented by the third level node 32 is further subdivided into three shots represented by fourth-level nodes 3, 4 and 5. The video sub-segment represented by the third level node 43 is further subdivided into four shots represented by fourth-level nodes 10, 11, 12 and 13. The video sub-segment represented by the third level node 44 is further subdivided into two shots represented by fourth-level nodes 14 and 15. The video segment represented by the second level node 42 is further subdivided into four shots represented by fourth-level nodes 6, 7, 8 and 9. Note that all of the automatically detected shots of the video stream 200 (represented by the nodes 1-15) are present at terminals, or “leaves” of the tree (i.e., they are not further subdivided).

Each node of a video hierarchy (such as the video hierarchies 210 and 220 of FIGS. 2A and 2B, respectively) represents a corresponding video segment. For example, a node labeled as 32 in FIG. 2B represents a video segment that consists of three shots represented by the nodes 3, 4 and 5. Any node can be further associated with metadata that describes characteristics of the video segment represented by the node (such as a start time, duration, title and key frame for the segment). For example, segment 32 in FIG. 2B has a start time which is equal to that of shot 3, a duration which is summation of those of shots 3, 4 and 5, a title which is typed by a user or derived by those of shots 3, 4 and 5, and a key frame which is chosen from the key frames of shots 3, 4, and 5.

Tree-structured video hierarchies of the type described hereinabove organize semantic information related to the semantic content of a video stream into groups of video segments, using an appropriate number of hierarchical levels to describe the (multi-tier) semantic structure of the video stream. The resulting semantically derived tree-structured hierarchy permits browsing the content by zooming-in and zooming-out to various levels of detail (i.e., by moving up and down the hierarchy). Typically, a video hierarchy is visualized as a key frame hierarchy on a computer screen. However, it is virtually impossible to show a complete key frame hierarchy on a computer display of limited size since the key frame hierarchy can have hundreds, thousands, or even hundreds of thousands of key frames related to video segments.

Conventional GUI for Browsing Hierarchical Video Structure

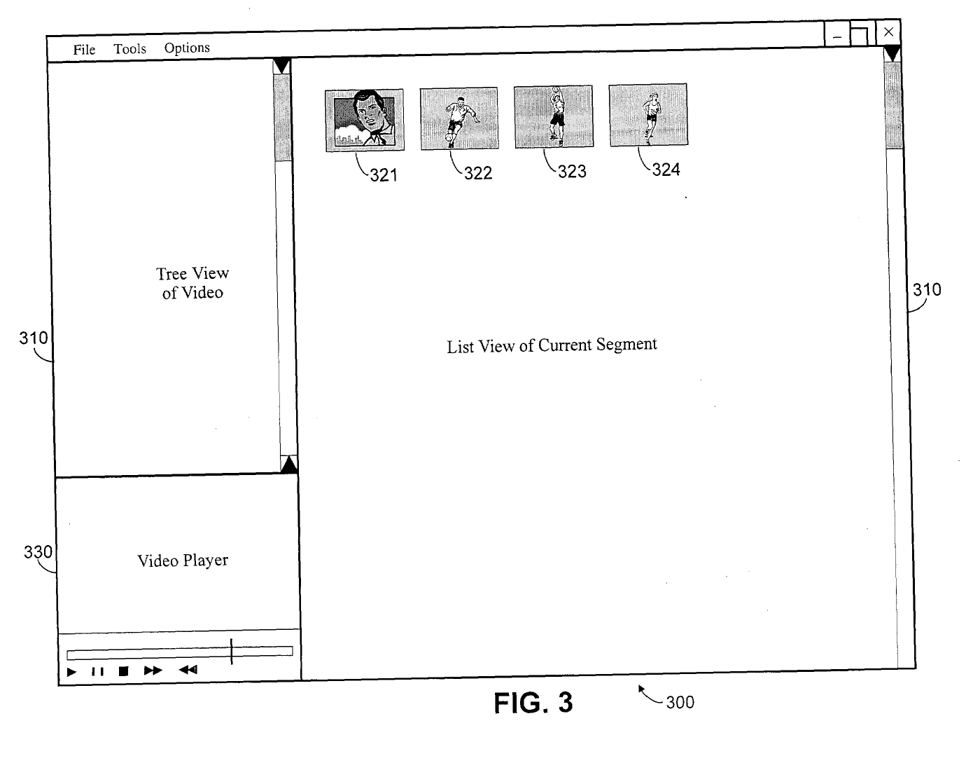

FIG. 3 is a screen image 300 from a program for browsing a tree-structured video hierarchy using a “conventional” windowed GUI (e.g., the GUIs of Microsoft Windows™, the Apple Macintosh, X Windows, etc.). The screen image comprises a tree view window 310, a list view window 320, and an optional video player 330. The tree view window 310 displays a tree view of the video hierarchy in a manner similar that used to display tree views of multi-level nested directory structure. Icons within the tree view represent nodes of the hierarchy (e.g., folder icons or other suitable icons representing nodes of the video hierarchy, and a title associated with each node). When a node is selected (highlighted) by the user in the tree view window, a list view for the video segment corresponding to the selected node appears in the list view window 320.

The list view window 320 displays a set of key frames (321, 322, 323 and 324), each key frame associated with a respective video segment (sub-segment or shot) making up the video segment associated with the selected node of the video hierarchy (each also representing a node of the hierarchy at a level one lower than that of the node selected in the tree view frame). Preferably, the video player 330 is set up to play a selected video segment, whether the video segment is selected via the tree view window 310 or the list view window 320.

2. GUI for Constructing and Browsing Hierarchical Video Structure

The present invention facilitates video browsing of a video hierarchy as well as facilitating efficient modeling by providing for easy reorganization/decomposition of an initial video hierarchy into intermediate hierarchies, and ultimately into a final multi-level tree-structured hierarchy. The modeling can be done manually, automatically or semi-automatically. Especially during the process of manual or semi-automatic modeling, the convenient GUIs of the present inventive technique increase the speed of the browsing and manual manipulation of hierarchies, providing a quick mechanism for checking the current status of intermediate hierarchies being constructed.

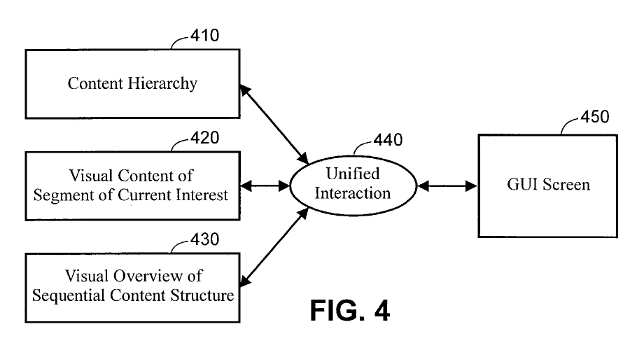

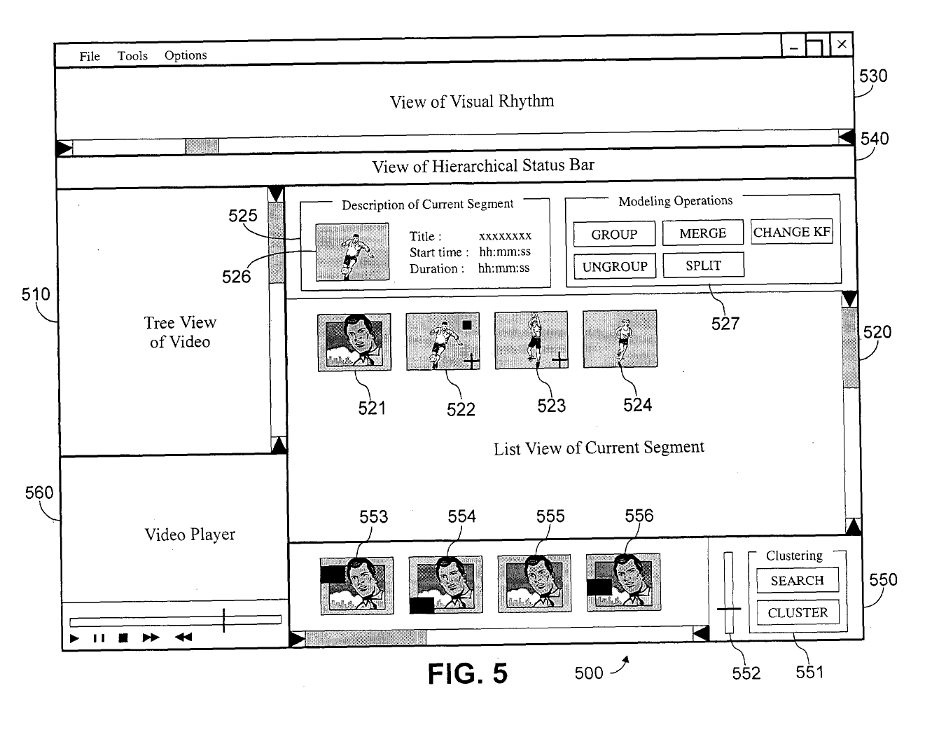

FIG. 4 is a block diagram of a system for browsing/editing video hierarchies, by means of three major visual components, or functional modules (410, 420 and 430), according to the invention. A content hierarchy 410 (video hierarchy of the type described hereinabove) module represents relationships between segments, sub-segments and shots of a video stream or video file. A visual content block 420 module represents visual information (e.g., representative key frame, video segment, etc.) for a selected segment within the hierarchy 410. A visual overview 430 of sequential content structure module is a visual browsing aid such as a visual rhythm for the video stream or video file. A unified interaction module 440 provides a mechanism for a user to view a graphical representation of the hierarchy 410 and select video segments therefrom (e.g., in the manner described hereinabove with respect to FIG. 3), display visual contents of a selected video segment, and to browse the video stream or file sequentially via the visual overview 430. The unified interaction module 440 controls interaction between the user and the content hierarchy 410, the visual content 420 and the visual overview 430, displaying the results via a GUI screen 450. (A typical screen image from the GUI screen 450 is shown and described hereinbelow with respect to FIG. 5.)

The GUI screen 450 simultaneously shows/visualizes graphical representation of the content hierarchy 410, the visual content 420 of a segment (sub-hierarchy) of current interest (i.e., a currently selected/highlighted segment—see description hereinabove with respect to FIG. 3 and hereinbelow with respect to FIG. 5), and the visual overview of a sequential content structure 430. Through the GUI screen 450, a user can readily view the current graphical tree structure of a video hierarchy. The user can also visually check the content of the segment of current interest as well as the contents of its sub-segments.

The tree view of a video 310 and the list view of a current segment 320 of FIG. 3 are examples of visual interfaces on the GUI screen showing the current status of the content hierarchy (410) and the segment of current interest (420), respectively.

The visual overview of a sequential content structure 430 is an important feature of the GUI of the present invention. The visual overview of a sequential content structure is a visual pattern representative of the sequential structure of the entire video stream (or video file) that provides a quick visual reference to both shot contents and shot boundaries. Preferably, a visual rhythm representation of the video stream (file) is used as the visual overview of a sequential content structure 430. The visual overview 430 is used for quickly examining or verifying/validating the video content on a segment-by-segment basis without repeatedly playing each segment. The visual overview 430 is also used for rapidly locating a specific segment of interest or for identifying separate semantic units (e.g., shots or sets of shots) in order to define video segments and their video sub-segments by quickly skimming through the video content without playback.

The unified interaction module 440 coordinates interactions between the user and the three major video information components 410, 420 and 430 via the GUI screen. The status of the three major components 410, 420, 430 is visualized on the GUI screen 450. The content hierarchy module 410, visual content of segment of current interest module 420 and visual overview of sequential content structure module 430 are tightly coupled (or synchronized) through the unified interaction module 440, and thus displayed on GUI screen 450.

FIG. 5 is a screen image 500 of the GUI screen 450 of FIG. 4 during a typical editing/browsing session, according to an embodiment of the invention. The GUI screen display comprises:

a tree view of a video stream/file 510 (compare 310),

a list view of a current segment 520 (compare 320),

a view of visual rhythm 530,

a view of hierarchical status bar 540,

another list view of key frame search 550, and

a video player 560 (compare 330).

Each of the five views (510, 520, 530, 540, 550) is encapsulated into its own GUI object through which the requests are received from a user and the responses to the requests are returned to the user. To support an integrated framework for modeling a video stream, the five views are designed to exchange close interactions with one another so that the effects of handling requests made via one particular view are reflected not only on the request-originating view, but are dynamically updated on the other views.

The tree view of a video 510, the list view of a current segment 520, and the view of visual rhythm 530 are mandatory, displaying key components of the Graphical User Interface for visualizing and interacting with content hierarchy 410, the visual content of the segment of current interest 420, and the visual overview of a sequential content structure 430 of FIG. 4, respectively. The view of hierarchical status bar 540, the “secondary” list view of key frame search 550, and the video player 560 are optional.

GUI for the Tree View of a Video

A tree view of a video is a hierarchical description of the content of the video. The tree view of the present invention comprises a root segment and any number of its child and grandchild segments. In general, any segment in the tree view can host any number of sub-segments as its own child segments. Therefore, the shape, size, or depth of the tree view depends only on the semantic complexity of the video, not limited by any external constraints.

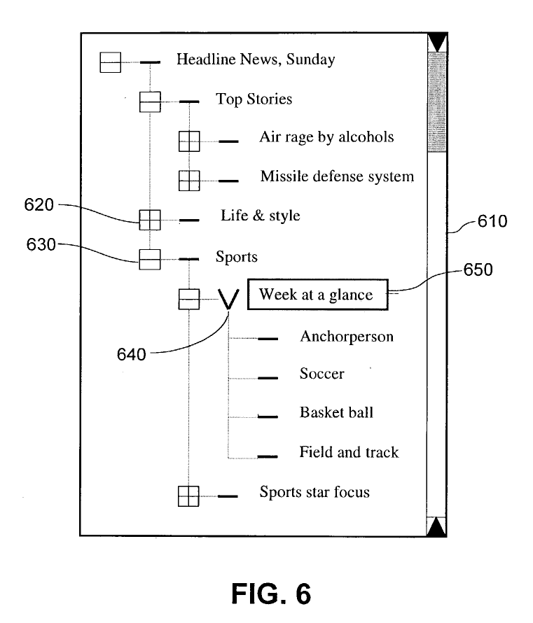

FIG. 6 is a screen image of a tree view 610 portion of a GUI screen according to an embodiment of the present invention. The tree view 610 (corresponding to the tree view 510 of FIG. 5) resembles the familiar “tree view” directories of Microsoft Windows Explorer. Any node at any level of the tree-structured hierarchy can be “collapsed” to display only the node itself or “expanded” to display nodes at the hierarchical layer below. Selecting a collapsed node (e.g., by clicking on the node with a mouse or other pointing device) expands the node to display underlying nodes. Selecting an expanded node collapses the node, hiding any underlying nodes. Each video segment, represented by a node in the tree view, has a title or textual description (similar to folder names in the directory tree views of Microsoft Windows Explorer.) For example, in FIG. 6, a root node is labeled “Headline News, Sunday”.

Collapsed nodes 620 are indicate by a plus sign (“+”) signifying that the node is being displayed in collapsed form and that there are underlying nodes, but they are hidden. Expanded nodes 630 are indicate by a minus sign (“−”) signifying that the node is being displayed in expanded form, with underlying nodes visible. If a collapsed node 620 is selected (e.g., by clicking with a mouse or other suitable pointing device), the collapsed node switches into the expanded form of display with a minus sign (“−”) displayed, and the underlying nodes are made visible. Conversely, if an expanded node 630 is selected, its underlying nodes are hidden and it switches to the collapsed form of display with a plus sign (“+”) displayed. A visibly distinctive (e.g., different color) check mark 640 indicates a current segment (currently selected segment).

Since the current selected segment (640) reflects a user choice, only one current segment should exist at a time. While skimming through the tree view 610, a user can select a segment at any level as the current segment, simply by clicking on it. The key frames (e.g., 521, 522, 523, 524) of all sub-segments of the current segment will then be displayed at the list view of the current segment (see 520 of FIG. 5). When the user clicks on a current segment, a small “edit” window 650 appears adjacent (near) the node representing that segment in order for the user to enter a semantic description or title for the segment. In this way, the user can add a short textual description to each segment (terminal or non-terminal) in the tree view.

GUI for the List View of a Current Segment

A list view of a current segment is a visual description of the content of the current segment, i.e., a “list” of the sub-segments (non-terminal) or shots (terminal) the current segment comprises. The list view of the present invention provides not only a textual list, but a visual “list” of key frames associated with the sub-segments of the current segment (e.g., in “thumbnail” form). The list view also includes a key frame for the current segment and a textual description associated therewith. There is no limitation on the number of key frames in the list of key frames.

Returning once again to FIG. 5, the list view element 520 of FIG. 5 illustrates an example of a GUI for the list view of a current segment, according to an embodiment of the present invention. The list view 520 of a current segment (a segment becomes a “current segment” when it is selected by the user via any of the views) shows a list of key frames 521, 522, 523 and 524 each of which represents a sub-segment of the current segment. The list view 520 also provides a metadata description 525 associated with the current segment, which may, for example, include the title, start time, duration of the current segment and a key frame image 526 associated with the current segment. The key frame 526 for the current segment is chosen from the key frames associated with sub-segments of the current segment.

In FIG. 5 the key frame 526 for the current segment is taken from the keyframe 522 associated with the second sub-segment of the current segment. A special symbol or indicator marking, (e.g., a small square at the top-right corner of sub-segment key frame 522, as shown in the figure) indicates that the key frame 522 has been selected as the key frame 526 for the current segment 525.

The list view 520 of a current segment displays key frame images for all sub-segments of the current segment. Two types of key frames are supported in the list view. The first type is a “plain” key frame (e.g., key frames 521 and 524, without indicator markings of any type). Plain key frames indicate that their associated sub-segment has no further sub-segments—i.e., they are video shots (the “leaves” of a video hierarchy; “terminals” or “granules” that cannot be further subdivided). The second type of key frame is a “marked” key frame that has an indicator marking disposed on or near the key frame image. In FIG. 5, key frames 522 and 523 are “marked” key frames with a plus symbol (“+”) indicator marking at the bottom-right corner of their respective display images. A marked key frame indicates that its associated sub-segment is further subdivided into sub-sub-segments. That is, the sub-segments associate with marked key frames 522 and 523 have their own sub-hierarchies. If a user selects a key frame with a plus symbol in the tree view 510, the associated segment becomes “promoted” to the new current segment, at which time its key frame image becomes the current segment keyframe (526), its metadata (525) is displayed, and key frame images for its associated sub-segments are displayed in the list view 520.

The list view 520 further provides a set of buttons for modeling operations 527: labeled with a variety of video modeling operations, such as “Group”, “Ungroup”, “Merge”, “Split”, and “Change Key frame”. These modeling operations are associated with semi-automatic video modeling, described in greater detail hereinbelow.

The tree view 510 and the list view 520 of the present invention are similar to the “tree” and “list” directory views of Microsoft Windows Explorer™, which displays a hierarchical structure of folders and files as a tree. Similarly, the GUI of the present inventive technique shows a hierarchical structure of segments and sub-segments as a tree. However, unlike the tree and list views of Microsoft Windows Explorer™ where folders and files are completely different entities, the segments and sub-segments of the tree and list views of the present inventive technique are essentially the same. That is, a folder can be considered as a container for storing files, but segments and sub-segments are both sets of frames (shots). In Microsoft Windows Explorer, a tree view of a file system shows a hierarchical structure of only folders, and a list view of a current folder shows a list of files and nested sub-folders belonging to the current folder along with the folder/file names. In the GUI of the present invention, a tree view of a video hierarchy shows a hierarchical structure of segments and their sub-segments simultaneously, and the list view of a current segment shows a list of key frames corresponding to the sub-segments of the current segment.

GUI for the View of Visual Rhythm

When the video hierarchy browsing/editing GUI of the present invention is first started, one of its first tasks is to create a visual rhythm image representation of the input video (stream or file) on which it will operate, (e.g., an ASF, MPEG-1, MPEG-2, etc.). Each vertical line of the visual rhythm consists of pixels that are sampled from a corresponding video frame according to a predetermined sampling rule. Typically, the sampled pixels are uniformly distributed along a diagonal line of the frame. One of the most significant features of any visual rhythm is that it exhibits visual patterns and/or visual features that make it easy to distinguish many different types of video effects or shot boundaries with the naked eye. For example, a visual rhythm exhibits a vertical line discontinuity for a “cut” (change of camera) and a curved/oblique line for a “wipe”. See, H. Kim, et al., “Visual rhythm and shot verification”, Multimedia Tools and Applications, Kluwer Academic Publishers, Vol.15, No.3 (2001).

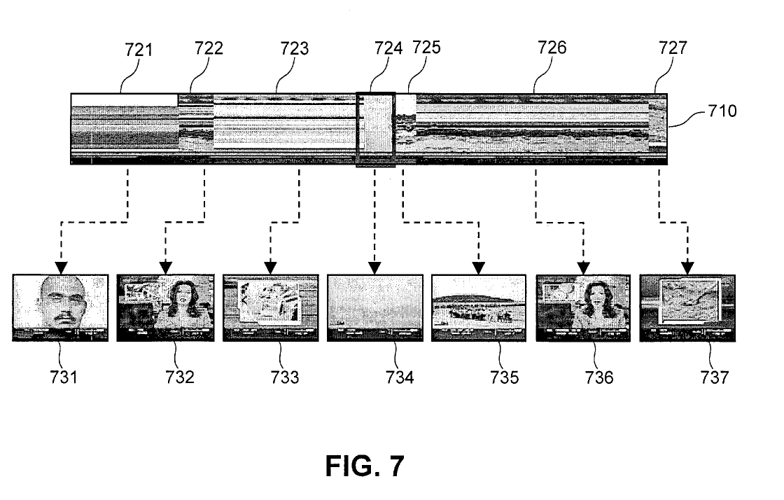

FIG. 7 shows a small portion of a visual rhythm 710 made from an actual video file with an upper-left-to-lower-right diagonal sampling strategy. The visual rhythm 710 has six vertical line discontinuities that mark shot boundaries resulting from a “cut” edit effect. In the visual rhythm, any area delimited by any of a variety of easily recognizable shot boundaries (e.g., boundaries resulting from a camera change by cut, fade, wipe, dissolve, etc.) is a shot. There are seven shots 721, 722, 723, 734, 725, 726 and 727 in the visual rhythm 710. In the figure, seven key frames from 731, 732, 733, 734, 735, 736 and 737 representing the shots 721, 722, 723, 734, 725, 726 and 727, respectively are shown. Simple examination of the visual characteristics of a visual rhythm of a video with extracted key frames (as shown in FIG. 7), a user can get a good indication of the video file's complete content without actually playing the video. For example, the video content corresponding to the visual rhythm 710 might be a news program. In the program, a news item might consist of shots 722, 723, 724 and 725, and another news item might start from an anchorperson shot 726. In the visual rhythm, a shot or a sequence of successive shots of interest can be readily detected (automatically) and marked visually. For example, the shot 724 may be outlined with a thick red box.

Each vertical line of the visual rhythm has associated itself with a time code (sampling time) and a frame ID, so that the visual rhythm can be accessed conveniently via one of these two values. To understand how and when these two values are used, consider playing back a segment of a video file corresponding to a marked area of the visual rhythm constructed from the video file. Two procedures might be involved to get this done. One is to show the marked area (shot) and the other one is to play the segment corresponding to the marked area (shot). The procedure of area (shot) marking on a visual rhythm is readily implemented using beginning and end frame IDs of the shot boundaries while the procedure of playing back requires the beginning and end time codes of the corresponding segment. (Note that a shot is a segment that cannot be further subdivided—i.e., there are no “camera changes” or special editing effects within a shot, by definition, since shots are delineated by such effects).

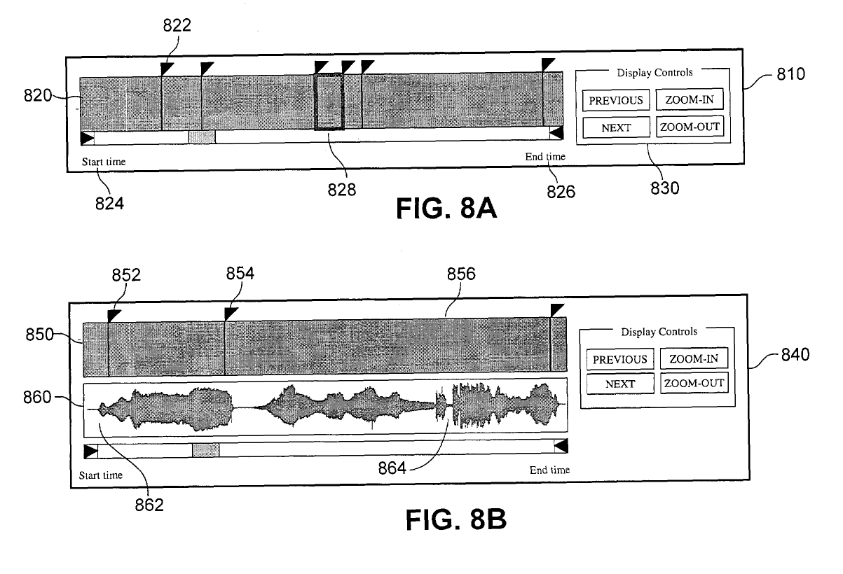

FIGS. 8A and 8B are screen images showing two examples of a GUI for viewing a visual rhythm, according to an embodiment of the present invention. In the GUI screen image 810 of FIG. 8A (corresponding to View of Visual Rhythm 530, FIG. 5), a small portion of a visual rhythm 820 is displayed. The shot boundaries are detected, using any suitable technique. The detected shot boundaries are shown graphically on the visual rhythm by placing a special symbol called “shot marker” 822 (e.g., a triangle marker as shown) at each shot boundary. The shot markers are adjacent the visual rhythm image. For a given shot (between two shot boundaries), rather than displaying a “true” visual rhythm image (e.g., 710), a “virtual” visual rhythm image is displayed as a simple, recognizable, distinguishable background pattern, such as horizontal lines, vertical lines, diagonal lines, crossed lines, plaids, herringbone, etc, rather than a true visual rhythm image, within its detected shot boundaries. In FIG. 8A, six shot markers 822 are shown, and seven distinct background patterns for detected shots are shown. The background patterns are selected from a suite of background patterns, and it should be understood that there is no need that the pattern bear any relationship to the type of shot which has been detected (e.g., dissolve, wipe, etc.). There should, of course, be at least two different background patterns so that adjacent shots can be visually distinguished from one another.

A highlighting box 828 (thick outline) indicates the currently selected shot. The outline of the box may be distinctively colored (e.g., red). A start time 824 and end time 826 for the displayed portion of the visual rhythm 810 are shown as either time codes or frame IDs. This visual rhythm view also includes a set of control buttons 830, labeled “PREVIOUS”, “NEXT”, “ZOOM-IN” and “ZOOM-OUT”. The “PREVIOUS” and “NEXT” buttons control gross navigation visual rhythm, essentially acting as “fast forward” and “fast backward” buttons (forwarding/reversing) for moving forwards or backwards through the visual rhythm to display another (e.g., adjacent subsequent or adjacent previous) portion of the visual rhythm according the visual rhythm's timeline. The “ZOOM-IN” and “ZOOM-OUT” buttons control the horizontal scale factor of the visual rhythm display.

FIG. 8B is a GUI screen image 840 showing another representation of a visual rhythm 850, where the visual rhythm and a synchronized audio waveform 860 are juxtaposed and displayed in parallel. In the GUI screen image 840 of FIG. 8B, the visual rhythm 850 and the audio waveform 860 are displayed along the same timeline. Though the visual rhythm alone helps users to visualize the video content very quickly, in some cases, a visual representation of audio information associated with the visual rhythm can make it easier to locate exact start time and end time positions of a video segment. For example, when an audio segment 862 does not match up cleanly with a video shot 852, it may be better to move the start position of the video shot 852 to match that of the audio segment 862, because humans can be more sensitive to audio than video. (To move the start position of a shot, either ahead or behind, the user can click on the shot marker and move it to the left or right.) Also, when a user wants to divide a shot into two shots (see “Set shot marker” operation, described hereinbelow) because the shot contains a significant semantic change (indicated by a distinct change in the associated audio waveform) around a particular time position, (e.g., 856), a user can easily locate the exact time 864 of the transition by simply examining the audio waveform 860. Using the audio waveform 860 along with the visual rhythm 850, a user can more easily adjust video segment boundaries by changing time positions of segment boundary, or divide a shot or combine adjacent shots into a single shot (see “Delete shot marker” and “Delete multiple shot markers” operations, described hereinbelow).

In order to synchronize the audio waveform with the visual rhythm, the time scales of both visual objects should be uniform. Since audio is usually encoded at constant sampling rate, there is no need for any other adjustments. However, the time scale of a visual rhythm might not be uniform if the video source (stream/file) is encoded using a variable frame rate encoding technique such as ASF. In this case, the time scale of the visual rhythm needs to be adjusted to be uniform. One simple way of adjustments is to make the number of vertical lines of the visual rhythm per a unit time interval, for example one second, be equal to the maximum frame rate of encoded video by adding extra vertical lines into a sparse unit time interval. These extra visual rhythm lines can be inserted by padding or duplicating the last vertical line in the current unit time interval. Another way of “linearizing” the visual rhythm is to maintain some fixed number of frames per unit time interval by either adding extra vertical lines into a sparse time interval or dropping selected lines from a densely populated time interval.

As employed by the present inventive technique, a visual rhythm serves a number of diverse purposes, including, but not limited to: shot verification while structuring or modeling a hierarchy of an entire video, schematic view of an entire video, and delineation/display of a segment of interest.

If a video modeling process were to start with a perfectly accurate list of detected shots—that is, a list of detected shots without any falsely detected or undetected shot—there would be no need for the shot verification. In practice, however, it is not uncommon for a shot boundary to be missed or for an “extra” (false) shot boundary to be detected. For example, if a shot boundary between shots 721 and 722 of FIG. 7 is not detected, then the key frame 732 cannot be displayed in the list view 520 of FIG. 5. As a result, a user might have difficulty identifying the news item consisting of shots 722, 723, 724 and 725. In order to construct a semantic hierarchy quickly and easily, it is important that such missing shots be quickly detected and corrected, preferably without resorting to playing the video stream/file. Visual rhythm makes it possible to find false positive (falsely detected) shots and false negative (undetected) shots quickly and easily without resorting to video playback.

To aid in the process of shot verification/validation using a visual rhythm image, the video modeling GUI of present invention provides three shot verification/validation operations: Set shot marker, Delete shot marker, and Delete multiple shot markers.

The “Set shot marker” operation (not shown) is used to manually insert a shot boundary that is not detected by an automatic shot detection. If, for example, a particular frame (a vertical line section of a visual rhythm image) has visual characteristics that cause a user to question the accuracy of automatically detected shot boundaries in its vicinity, the user moves a cursor to that point in the visual rhythm image, which causes the GUI to display a predetermined number of thumbnails (frame images) surrounding the frame in question in a separate pop-up window. By examining the images in the pop-up window; the user can easily determine the validity of the shot boundary around the frame by examining the displayed thumbnails. If the user determines that there is an undetected shot boundary, the user selects an appropriate thumbnail image to associate with the undetected shot boundary (i.e., beginning of the undetected shot), e.g., by moving a cursor over the thumbnail image with a mouse and double clicking on the thumbnail image. A new shot boundary is created at the point the use has indicated, and a new shot marker is placed at a corresponding point along the visual rhythm image. In this way, a single shot is easily divided into two separate shots.

The “Delete shot marker” operation (not shown) is used to manually delete a shot boundary that is either falsely detected by automatic shot detection or that is not desired. The user actions required to delete a marked shot boundary using the “Delete shot marker” operation are similar to those described above for inserting a shot boundary using the “Set shot marker” operation. If a user determines (by examining thumbnail images corresponding to frames surrounding a marked shot boundary) that a particular shot boundary has either been incorrectly detected and marked, or that a particular shot boundary is no longer desired, the user selects the shot marker to be deleted, and the shot boundary in question is deleted by the GUI of the present invention, effectively joining the two shots surrounding the deleted boundary into a single shot. The user selects the shot boundary to delete by a suitable GUI interaction, e.g., by moving a cursor over a start thumbnail associated with the shot boundary (indicated by a shot marker) double clicking on the start thumbnail. The shot marker associated with the deleted shot boundary is removed from its corresponding frame position on the visual rhythm image, along with any other indication or marker (e.g., on a thumbnail image) associated with the deleted shot boundary.

Alternatively, as a short cut to the “Delete shot marker” operation described in the previous paragraph, if the user moves the cursor to a shot marker of the falsely detected shot on the view of visual rhythm and double clicks on the marker, he is asked to confirm the deletion of the shot marker. If the user confirms his selection, the marker (and its associated shot boundary and any other indicators associated therewith) is deleted.

The “Delete multiple shot markers” operation (not shown) is an extension of the aforementioned “Delete shot marker” operation except that the former can delete several consecutive shot markers at a time by selecting multiple shot markers (i.e., by selecting a group of shot markers) and performing an appropriate action (e.g., double-clicking on any of the selected markers with a mouse). The multiple shot markers, their associated shot boundaries and any other associated indicators (e.g., indicator markings on displayed thumbnail images) are removed, effectively grouping all of the shots bounded by at least one of the affected shot boundaries into a single shot.

Most shot detection algorithms frequently produce falsely detected consecutive shot boundaries for animated films, for complex 3D graphics (such as the leading titles of story units), for complex text captions having diverse special effects, for action scenes having many gun shootings, etc. In those cases, it would be a time-consuming process to delete the shot boundaries in question one at a time using the “Delete shot marker” operation. Instead, the “Delete multiple shot markers” operation can be used to great advantage. If a run of falsely detected shots are found by visual inspection of the visual rhythm (and or thumbnail images), the user moves the cursor to a shot marker of a first falsely detected shot boundary on the visual rhythm image and “drag-selects” all of the shot markers to be deleted (e.g., by clicking on a mouse button and dragging the cursor over the last shot marker to be deleted, then releasing the mouse button). The user is asked to confirm the deletion of all the selected shot markers (and, implicitly, their associated shot boundaries). If the user confirms his selection, all of the falsely detected shots are appended to the shot that is located just before the first one, and their corresponding shot markers will disappear on the view of visual rhythm.

In addition, the visual rhythm can be used to effectively convey a concise view or visual summary of the whole video. The visual rhythm can be shown at any of a wide range of time resolutions. That is, it can be super-sampled/sub-sampled with respect to time so that the user can expand or reduce the displayed width of the visual rhythm image without seriously impairing its visual characteristics. A visual rhythm image can be enlarged horizontally (i.e., “zoomed-in”) to examine small details, or it might be reduced horizontally (i.e., “zoomed-out”) to view visual rhythm patterns that occur over a longer portion of the video stream. Furthermore, a visual rhythm image displayed at its “native” resolution (which will not likely fit on screen all at once) can be “scrolled” left or right from beginning to the end with a few mouse clicks on the “Previous” and “Next” buttons. The display control buttons 830 of FIGS. 8A and 8B are used for these purposes.

Visual rhythm can also be used to enable a user to select a segment of interest easily, and to mark the selected segment on the visual rhythm image. Specifically, if a user selects any area between any two shot boundary markers (e.g., by appropriate mouse movement to indicate an area selection) on the visual rhythm image, the area delimited by the two shot boundaries is selected and indicated graphically—for example, with a thick (e.g., red) box around it, such as the area 724 of FIG. 7 or the area 828 of FIG. 8A. A selection made in this way is not limited to selection of elements such as frames, shots, scenes, etc. Rather, it permits selection of any possible structural grouping of these elements making up a hierarchical video tree.

GUI for the View of Hierarchical Status Bar

A useful graphical indicator, called a “hierarchical status bar”, can be employed by the GUI of the present invention to give a compact and concise timeline map of a video hierarchy. This hierarchical status bar is another representation of a video hierarchy emphasizing the relative durations and temporal positions of video segments in the hierarchy. The hierarchical status bar represents the durations and positions of all segments that along related branches of a video hierarchy from a root segment to a current segment as a segmented bar having a plurality of visually-distinct (e.g., differently-colored or patterned) bar segments. Each bar segment has a length and a visual characteristic (color, pattern, etc.) that identify the relative length (duration) and relative position, respectively, of a current segment with respect to the total duration associated with the root segment of the hierarchy (the whole video stream/file represented by the video hierarchy).

FIG. 9 is a diagram showing the relationship between a video hierarchy 960 (compare FIG. 2B and FIG. 12C) and a hierarchical status bar 910. In FIG. 9, the hierarchical status bar 910 provides a temporal summary view of the video hierarchy 960. In the video hierarchy 960, a plurality of nodes (labeled 1-15, 21, 31, 32 and 41-45—compare with the video hierarchy 220 of FIG. 2B) whose interconnectedness in the video hierarchy represents a semantic organization of corresponding video segments represented by the hierarchy, as described hereinabove with respect to FIGS. 2 and 2B. It should be noted that while the video hierarchy 960, as represented in FIG. 9, is a representation abstraction of a semantic organizational structure, the hierarchical status bar 910 is a graphical representation intended to be shown on a GUI display screen. The video hierarchy 960 and the hierarchical status bar 910 are shown juxtaposed in FIG. 9 strictly for purposes of illustrating a relationship therebetween. One of the leaf nodes (12) of the video hierarchy 960 representing a specific video shot is highlighted to indicate that its associated video segment (shot, in this case) is the current segment. Since there are four nodes of the hierarchy 960 along the path from the root node 21 to node 12 representing the current segment (including the root node and the highlighted node 12) the hierarchical status bar 910 has four separate bar segments 920, 930, 940, and 950 each of which is shaded or colored differently, and displayed in an overlaid hierarchical configuration. An overlaid configuration is one in a bar segment corresponding to a node at a particular level of the hierarchy will obscure any portion of a bar segment at a higher hierarchical level that it overlies.

Root level bar segment 920 corresponds to the root node 21 at the highest level of the video hierarchy 960, and its relative length represents the relative duration of the root segment (the whole video stream/file) associated with the root node 21. Second-level bar segment 930 overlies the root level bar segment 920, obscuring a portion thereof, and represents second-level node 45. The relative length of the second-level bar segment 930 represents the relative duration of the video segment associated with the second-level node 45 (a sub-segment of the root segment), and its position relative to the root-level bar segment 920 represents the relative position (within the video stream/file) of the video segment associate with the second-level node 45 relative to the root segment. Third-level bar segment 940 overlies the second-level bar segment 930, obscuring a portion thereof, and represents third-level node 43. The relative length of the third-level bar segment 940 represents the relative duration of the video segment associated with the third-level node 43 (a sub-segment of the second-level segment), and its position relative to the root-level bar segment 920 and second-level bar segment 930 represents the relative position (within the video stream/file) of the video segment associated with the third-level node 43. Fourth-level bar segment 950 overlies the third-level bar segment 940, obscuring a portion thereof, and represents fourth-level node 12 (a “leaf” node representing the currently selected video segment). The relative length of the fourth-level bar segment 950 represents the relative duration of the video segment associated with the fourth-level node 12 (a sub-segment of the third-level segment, and a “shot” since it is at a lowest level of the video hierarchy 960), and its position relative to the root-level bar segment 920, second-level bar segment 930 and third-level bar segment 940 represents the relative position (within the video stream/file) of the video segment associated with the third-level node 43.

The “deeper” a selected segment lies within a tree-structured video hierarchy, the more bar segments are required to represent its relative temporal position and length within the hierarchy. Preferably, the color/shading/pattern for each bar segment in a hierarchical status bar is unique to the hierarchical level it represents.

In addition to conveying (displaying) information about the temporal and hierarchical locations of a selected video segment, the hierarchical status bar can be used as yet another interactive means of navigating the video hierarchy to locate specific video segments or shots of interest. This is accomplished by taking advantage of the overall “timeline” appearance of the hierarchical status bar, whereby any horizontal position along the status bar represents a particular portion (video segment) of the video stream/file that occurs at an associated time during playback of the stream/file. By making an appropriate interactive selection at any horizontal position along the hierarchical status bar (e.g., by moving a mouse cursor to that point and clicking) the video segment associated with that position is highlighted in both the tree view and visual rhythm view.

GUI for the List View of Key frame Search

The present inventive technique provides a GUI and underlying processes for facilitating semi-automatic video modeling by combining automated semantic clustering techniques with manual modeling operations. In addition to the manual modeling techniques described hereinabove (i.e., editing/revision of automatically detected shots and their hierarchical organization, insertion/deletion of shot boundaries, etc.) the GUI for the list view provides automatic semantic clustering (automatic organization of semantically related shots/segments into a sub-hierarchy).

Automatic semantic clustering is accomplished by designating a key frame image associated with a shot/segment as reference key frame image, searching for those shots whose key frame images exhibit visual similarities to the reference key frame image, and grouping those “similar” shots and shots surrounded by them into one or more sub-hierarchical groupings or “clusters”. By way of example, this technique could be used to find recurring anchorperson shots in a news program.

With reference to FIG. 5, the element 550 illustrates an example of a GUI for the list view of key frame search according to an embodiment of the present invention. The list view of key frame search 550 provides two clustering control buttons 551 labeled “Search” and “Cluster”. This list view is used for the semantic clustering as follows.

A user first specifies a clustering range by selecting any segment in the tree view of a video 510 (e.g., by “clicking” on its associated key-framing image (thumbnail) with a mouse). Semantic clustering is applied only within the specified range, that is, within the sub-hierarchy associated with the selected segment (the sub-tree of segments/shots the selected segment comprises).

The user then designates a query frame (reference key frame image) by clicking on a key frame image (thumbnail) in the list view of selected segment 520, and clicks on the “Search” button. A content-based key frame search algorithm then searches for shots within the specified range whose key frames exhibit visual similarities to the selected (designated) query frame, using any suitable search algorithm for comparing and matching key frames, such as has been described in the aforementioned U.S. patent application Ser. No. 09/911,293.

After identifying related shots within the specified range, the GUI for the list view of key frame search 550 then shows (displays) a list of temporally-ordered key frames 553, 554, 555, and 556, each of which represents a shot exhibiting visual similarities to the query frame.

The list view also provides a slide bar 552 with which the user can adjust a similarity threshold value for the key frame search algorithm at any time. The similarity threshold indicates to the key frame search algorithm the degree of visual key frame similarity required for a shot to be detected by the algorithm. If, after examining the key frames for the shots detected by the algorithm, the user determines that the search results are not satisfactory, the user can re-adjust the similarity threshold value and re-trigger the “Search” control button 551 of many times as desired until the user determines that the results are satisfactory.

After achieving satisfactory search results, the user can trigger the “Cluster” control button 551, which replaces the current sub-hierarchy of the selected segment with a new semantic hierarchy by iteratively grouping intermediate shots between each pair of adjacent detected shots into single segments. This process is explained in greater detail hereinbelow.

Unified Interactions Between the GUIs

Each GUI object of the present invention plays a pivotal role of creating and sustaining intimate interactions with other GUI objects. Specifically, if a request for video browsing or modeling action originates within a particular GUI, the request is delivered simultaneously to the other GUIs. According to the received messages, the GUIs update their own status, thereby conveying a consistent and unified view of the browsing and modeling task.

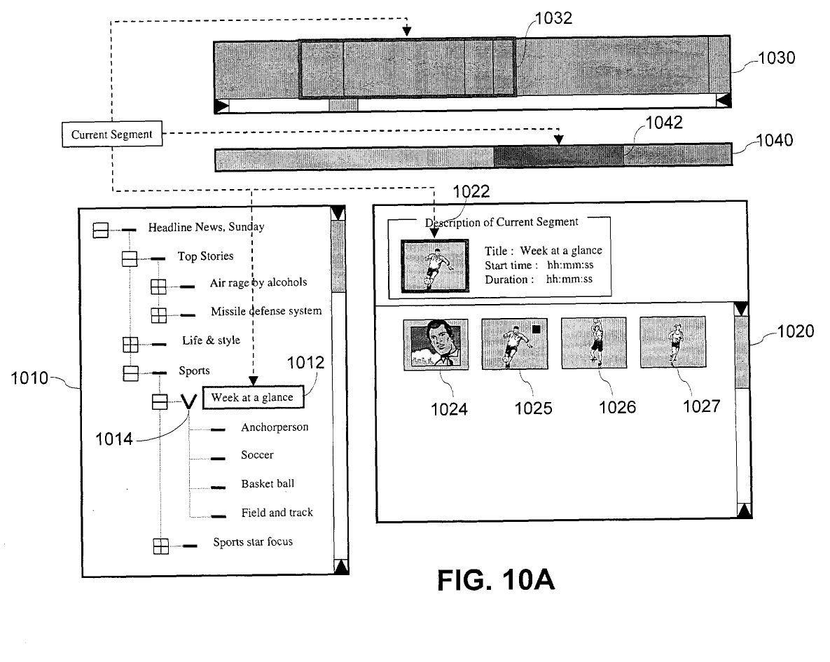

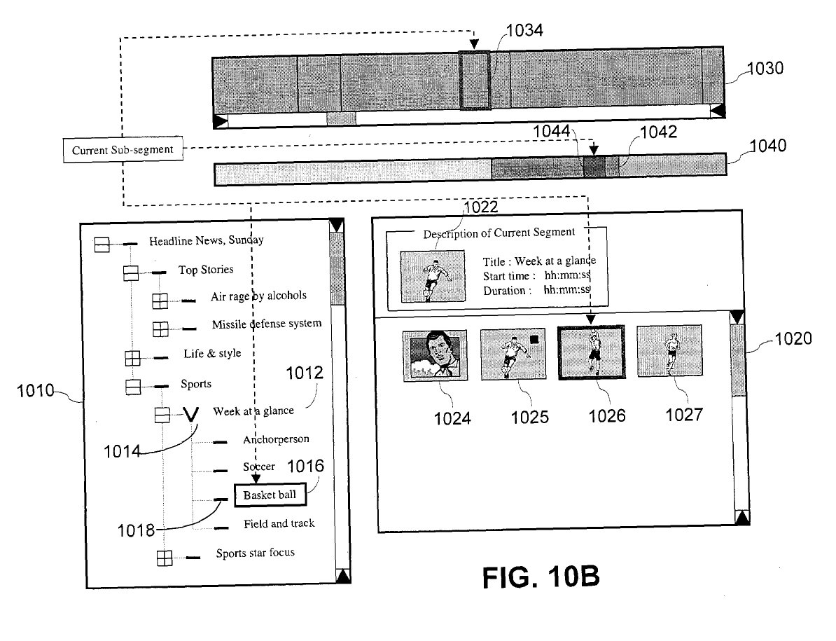

FIGS. 10A and 10B illustrates two examples of unified GUI screens according to an embodiment of the present invention.

FIG. 10A illustrates what happens when a user selects (clicks on, requests) a segment 1012 (shown highlighted) in the tree view of a video 1010 (compare 510, 650). The segment 1012 has four sub-segments, and is displayed as a requested “current segment” by displaying a visually distinctive (e.g., red check) mark 1014 (compare 640) before the title of the segment. This request is propagated to the list view of the current segment 1020 (compare 520), to the view of visual rhythm 1030 (compare 530), and to the view of hierarchical status bar 1040 (compare 540). In the list view 1020, the key frame 1022 of the current segment is displayed in a visually distinctive (e.g., thick red) box with some textual description of the requested segment, and a list of key frames 1024, 1025, 1026, 1027 representing the four sub-segments of the current segment respectively. In the view of visual rhythm 1030, the area 1032 corresponding to the current segment is also displayed in a visually distinctive manner (e.g., a thick red box). In the view of hierarchical status bar 1040, three visually distinctive (e.g., different colored) bars corresponding to the three segments that lie in the path from the root segment to the current segment are displayed. Preferably, the bar 1042 corresponding to the current segment is distinctively colored (e.g., in red).

FIG. 10B illustrates what happens when the user clicks on a segment 1016 that has no sub-segment. The segment 1016 is displayed as a current sub-segment by coloring (e.g.) the small bar (−) symbol 1018 before the title of the sub-segment in red (e.g.). Similarly, this request is then propagated to the list view of the current segment 1020, the view of visual rhythm 1030, and the view of hierarchical status bar 1040. In the list view 1020, the thick red box moves to the key frame of the new current sub-segment 1026. In the view of visual rhythm 1030, the thick red box also moves to the area 1034 corresponding to the current sub-segment. In the view of hierarchical status bar 1040, four different colored bars corresponding to the four segments that lie in the path from the root segment to the current sub-segment are displayed. Especially, the bar corresponding to the current sub-segment 1044 is colored in red.

If the segment 1016 of FIG. 10B has its own sub-segments when the user clicks on the segment, the segment becomes a new current segment, not a current sub-segment. Then all the four views 1010, 1020, 1030 and 1040 will be redisplayed such as FIG. 10A. In this manner, a user can browse any part of a hierarchical structure.

The unified GUI screen of the present invention provides the user with the following advantages. With the tree view of a video and the list view of a current segment together, a user can browse a hierarchical video structure segment by segment. With the aid of the visual rhythm and the list of key frames, the user can scrutinize the shot boundaries of the entire video content without playing it. Also the user can have a visual overview or summary of the whole video content, thus having a gross (coarse) or conceptual view of high-level segments. Furthermore, the hierarchical status bar provides the user information on the nested relationships, relative durations, and relative positions of related video segments graphically. All those merits enable the user to browse and construct the hierarchical structure fast and easily.

3. Semi-Automatic Video Modeling

The process of organizing a plurality of video segments of a video stream into a multi-level hierarchical structure is known as “modeling” of the content of the video stream, or just “video modeling”. Video modeling can be done manually, automatically or semi-automatically. Since manual modeling requires much time and effort of a user, automated video modeling is preferable. However, the hierarchy of a video resulting from automated video modeling does not always reflect the semantic structure of the video because of the semantic complexity of the video content, thus requiring some human intervention. The present invention provides a systematic method for semi-automatic video modeling where manual and automatic methods can be interleaved in any order, and applying them as many times as a user wants.

Syntactic and Semantic Clustering

Automatic clustering helps a user to build a semantic hierarchy of a video fast and easily, although its resulting hierarchy might not reflect real semantic structure well, thus requiring human correction or editing of the hierarchy.

According to the invention, a user can specify a clustering range before clustering will start. The clustering range is a scope within which the clustering schemes in the present invention are applied. If the user does not specify the range, the whole video becomes the range by default. Otherwise, the user can select any segment as a clustering range. With the clustering range, the automatic clustering can be selectively applied to any segment of the current hierarchy.

According to the invention, two techniques for automatic clustering (shot grouping) are provided: “syntactic clustering” and “semantic clustering”. Both techniques start with the premise that shots have been detected, and key frames for the shots have been designated, by any suitable shot detection methods.

Generally, the syntactic clustering technique works by grouping together visually similar consecutive shots based on the similarities of their key frames. Generally, the semantic clustering technique works by grouping together consecutive shots between two recurring shots if the recurring shots are present. One of the recurring shots is manually chosen by a user with human inspection of the key frames of the shots, and the key frame of the selected shot is then given to a key frame search algorithm as a query (or reference) image in order to find all remaining recurring shots within a clustering range. Both shot grouping techniques make the current sub-hierarchy of the selected segment grow one level deeper by creating a parent segment for each group of the clustered shots.

More particularly, the semantic clustering technique works as follows. The semantic clustering technique takes a query frame as input and searches for the shots whose key frame is similar to the query. As has been described hereinabove, the query (reference) frame is selected by a user from a list of key frames of the detected shots. The shots represented by the resulting key frames are then temporally ordered. The next step is to group all the intermediate shots between any two adjacent retrieved shots into a new segment, wherein either the first or the last of the two retrieved shots is also included into the new segment. The resulting sub-hierarchy thus grows one level deeper. This semantic clustering technique is very well suited to video modeling of news and educational videos that often have recurring unique and regular shots. For example, an anchorperson shot usually appears at the beginning of each news item of a news program, or a chapter summary having similar visual background appears at the end of each chapter of an educational video.

Modeling Operations

Even after the automatic clustering techniques (schemes) have been performed, with or without human intervention, the resulting structure of a hierarchy does not always reflect the semantic structure of a video exactly. Thus, the present invention offers a number of operations, called “modeling operations” to manually edit the structure of the hierarchy. These modeling operations include: “group”, “ungroup”, “merge”, “split” and “change key frame”. Other modeling operations are within the scope of the invention.

The “group”, “ungroup”, “merge”, and “split” operations are for manipulating the structure of the hierarchy. The “change key frame” operation is not related to manipulate the structure of the hierarchy. Rather, it is related to change the description of a segment in the hierarchy. With a proper combination of the modeling operations (except the “change key frame”), one can readily transform an undesirable hierarchy into the desirable one.

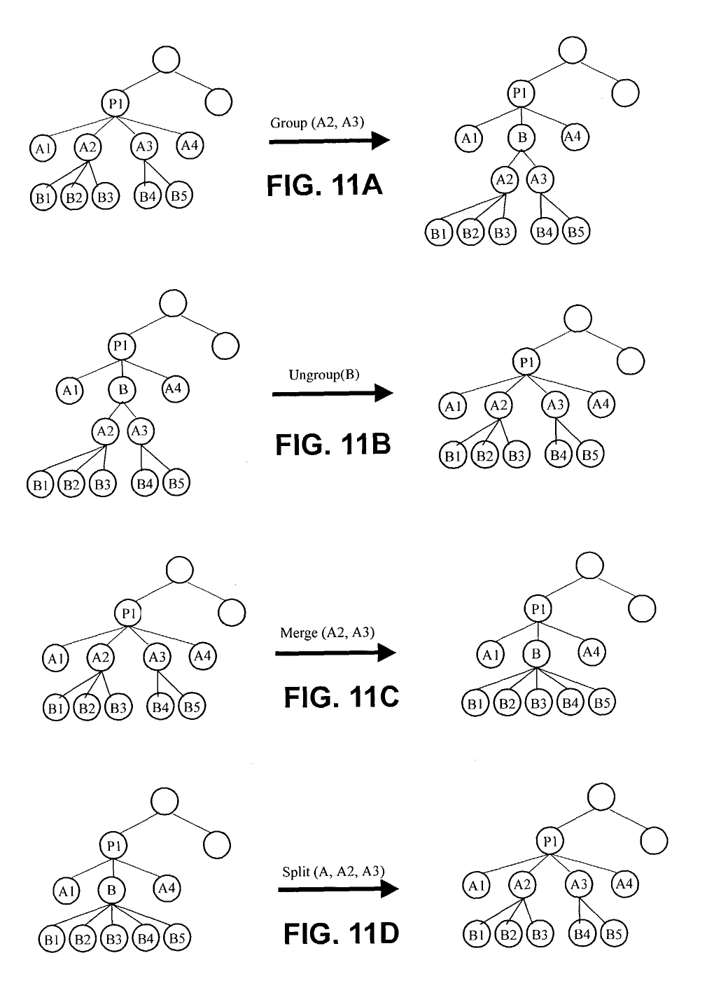

FIGS. 11A, 11B, 11C and 11D illustrate in greater detail the four modeling operations of “group”, “ungroup”, “merge”, and “split”, respectively, as follows:

a) Group: Taking a set of adjacent sibling segments (nodes) as an input, the group operation creates a new node that is to be inserted as a child node of the siblings' parent node, and then makes the new node parent to the sibling segments which are “grouped”. For example, FIG. 11A illustrates a four-level hierarchy having four segments A1, A2, A3 and A4 which are siblings of one another under a parent node P1. Two adjacent sibling nodes A2 and A3 are grouped by creating a new node B as a sibling of the nodes A1 and A4, and making the nodes A2 and A3 as children of the newly created node B. As a result of the grouping operation, the resulting sub-hierarchy grows one level deeper.

b) Ungroup: This is essentially the inverse of the group operation. Given a segment, the ungroup operation removes the segment by making the parent of the segment as the new parent for all child segments of the segment. For example, in FIG. 11B, the node B is ungrouped by making its parent as a parent of all its child nodes A2 and A3, and then deleting the node B. Thus, the resulting sub-hierarchy shrinks one level shorter. Notice that FIG. 11B (left) is the same as FIG. 11A (right), and that FIG. 11B (right) is the same as FIG. 11A (left).

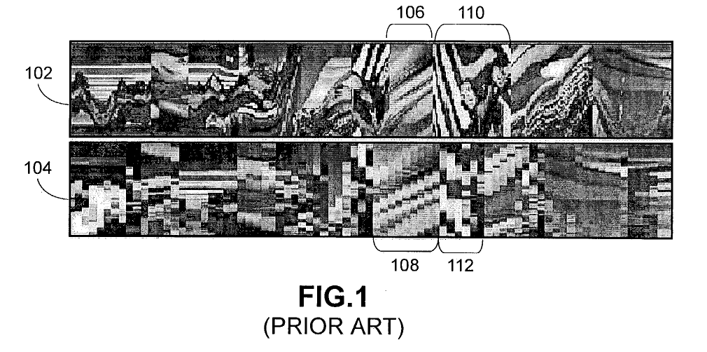

c) Merge: Given a set of adjacent sibling segments as an input, the merge operation creates a new segment that is to be inserted as a child segment of the siblings' parent segment. Then, it makes the new segment as a parent segment for all child segments under the siblings. Finally, it deletes all the input sibling segments. In FIG. 11C, the adjacent nodes A2 and A3 are merged by creating the new node A as an adjacent sibling of one of the nodes, and making all their children B1, B2, B3, B4 and B5 as children of the newly created node A, and then deleting the nodes A2 and A3. The level (depth) of the resulting sub-hierarchy does not change. Essentially, in the merge operation, “cousin” nodes (children of sibling parents) are merged under one new parent (the original two parents having been merged). Notice that FIG. 11C (left) is the same as FIG. 1A (left).

d) Split: This is essentially the inverse of the merge operation. Given a segment whose children can be divided into two disjoint sets of child segments, the split operation decomposes the segment into two new segments each of which has the set of child segments as its child segments respectively. In FIG. 11D, the child nodes B1, B2, B3, B4 and B5 of the node A are split between the nodes B3 and B4 by creating the new nodes A1 and A2 as new adjacent siblings of the node A, and making the two set of child nodes B1, B2, B3 and B4, B5 as children of the newly created nodes A2 and A3 respectively, and then deleting the node A. The level of the resulting sub-hierarchy does not change. Notice that FIG. 11D (left) is the same as FIG. 11C (right), and that FIG. 11D (right) is the same as FIG. 11C (left). In addition to the operations for manipulating the hierarchy, there is the “change key frame” modeling operation, as follows:

e) Change key frame: Given a segment, the “change key frame” operation replaces the key frame of the parent of the given segment with the key frame of the given segment.

GUI for Modeling Operations

The modeling operations are provided in the list view 520 of a current segment 525 of FIG. 5. Modeling is invoked by the user selecting input segments from the list of key frames representing the sub-segments of the current segment in the list view 520, and clicking on one of the buttons for modeling operations 527. In order to carry out the modeling operations, a way to select some number of sub-segments is provided. In the list of key frames representing the sub-segments of the current segment in the list view 520, the sub-segments may be selected by simply clicking on their key frames. Such selected sub-segments are highlighted or marked in a particular color, for example, in red. After a sub-segment is selected, if another sub-segment is clicked again, then all the intervening sub-segments between the two sub-segments are selected.

If a user presses the right mouse button upon a key frame in the list view 520, a popup window (not shown) with various playback options appears. For example, the list view 520 can support three options: “Play back the segment”, “Play back the key sub-segment”, and “Play back the sequence of the segments”. The “Playback the segment” menu is activated to play back the marked segment in its entirety. The “Playback the key sub-segment” option plays back only the child segment whose key frame is selected as the key frame of the marked segment. Lastly, the “Play back the sequence of the segments” option plays back all the marked segments successively in the temporal order.

Different playback modes are enabled for different sub-segment types. A sub-segment having none of its own sub-segment comes with only “Play back the segment” option. For a sub-segment with its own sub-hierarchy, that is, represented by a key frame with a plus symbol, “Play back the segment” and “Play back the key sub-segment” options are enabled. The “Play back the sequence of the segments” option is enabled only for a collection of marked sub-segments. The marked sub-segment or sequence of marked sub-segments is played at the video player 560.

Integrated Process of Semi-Automatic Video Modeling

FIGS. 12A, 12B and 12C illustrate an example of the semi-automatic video modeling in which manual editing of a hierarchy follows after automatic clustering FIG. 12A shows a video structure with two-level hierarchy 1210 where the segments labeled from 1 to 15 are shots detected by a suitable shot detection algorithm. Each leaf node is represented by a key frame (not shown) that is selected by a suitable key frame selection algorithm, and each non-leaf node including the root node is represented by one of the key frames of its children. This initial structure is automatically made by applying the group operation (described above) to all the detected shots. After constructing the initial structure, the semantic clustering is applied to the root segment 21 as a clustering range.

For example, a video corresponding to the hierarchy 1210 has fifteen shots 1-15, and is a news program with five recurring anchorperson shots labeled as 1, 3, 6, 10 and 14. >From a list of key frames of the detected shots (520 list view showing key frames for sub-segments), a user selects the key frame of the anchorperson shot labeled as 6 as a query image, and executes a suitable automatic key frame search which searches for (detects) shots whose key frame is similar to the query image, and the five shots labeled as 1, 3, 6, 8, 10 are returned. In this example, the anchorperson shot 14 is not detected, and the shot 8 is falsely detected as an anchorperson shot. Then, the group operation is automatically applied five times using the five resulting anchorperson shots. FIG. 12B shows a resulting video structure with three-level hierarchy 1220.

In the resulting hierarchy 1220, the user can observe that the segment 34 does not start with an anchorperson shot, and the segment 35 has two separate news items that start with the anchorperson shots 10 and 14 respectively. Thus, the user may decide to make the segments 33 and 34 into a single segment by utilizing the merge operation described hereinabove. Also, the user may decide to make the segment 35 into two separate sub-segments by utilizing the split and group operations described hereinabove.

Further, the user may decide to make a high level abstraction over the segments 31 and 32 by utilizing the group operation. FIG. 12C shows a resulting video structure with four-level hierarchy 1230 by applying those manual modeling operations. In the FIG. 12C, the segment 41 is created by grouping the two segments 31 and 32, the segment 42 by merging the segments 33 and 34 of FIG. 12B. Similarly, the segments 43 and 44 are created by splitting the segment 35 of FIG. 12B, the segment 45 by grouping the segments 43 and 44.

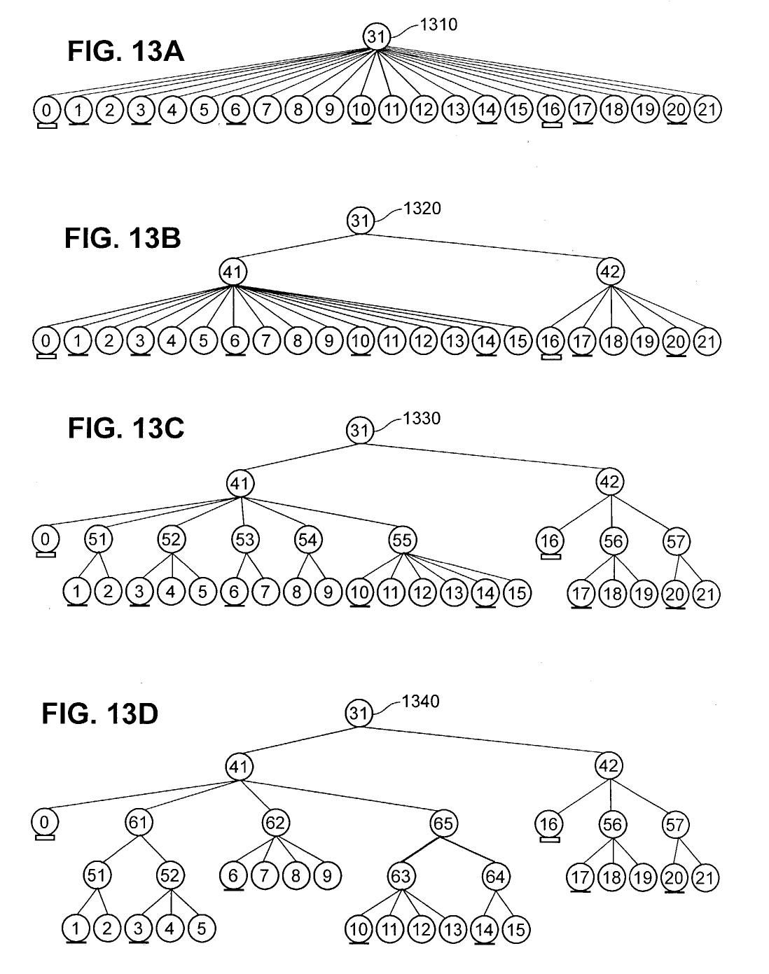

FIGS. 13A, 13B, 13C and 13D illustrate another example of the semi-automatic video modeling in which defining story units is manually done first, and then automatic clustering and manual editing of a hierarchy follows in sequence, according to an embodiment of the present invention.

As mentioned above, a typical news program may have a number of story units, each of which consists of several news items, each story unit has its own leading title segment that lasts just a few seconds, but signals beginning of higher semantic unit, the story unit.

FIG. 13A shows another video structure with a two-level hierarchy 1310 where the segments labeled from 0 to 21 are detected shots. In FIG. 13A, the nodes 1, 3, 6, 10, 14, 17 and 20 are anchorperson shots, and the nodes 0 and 16 are the leading title shots that signal the beginning of story units such as “Top stories” and “Dollars and Sense” of CNN news. If the semantic clustering algorithm with the recurring anchorperson shots as a query image is applied first for the hierarchy 1310, the shots 14, 15 and 16 will be clustered into a single segment. In this case, it will be difficult to cluster shots into the two story units because it is very hard for a user to find out such title shots among clustered segments with his visual inspection. In the present invention, the user can manually cluster shots using such title shots first, and then execute the clustering schemes.

FIG. 13B shows a video structure with three-level hierarchy 1320. The hierarchy is obtained by manually applying the group operation twice to the two-level structure 1310 using the two leading title shots 0 and 16. By this manual grouping, two story units 41 and 42 are made.

FIG. 13C shows a video structure 1330 that is obtained by executing the semantic clustering for each story unit 41 and 42 respectively. For example, a semantic clustering with the anchorperson shot 6 as a query image and another semantic clustering with the anchorperson shot 17 as a query image are executed. As shown in FIG. 13C, the latter clustering (using shot 17 as the query image) finds another anchorperson shot 20 within the story unit 42, thus making new segments or news items 56 and 57. However, in this example, the former (using shot 6 as the query image) does not detect the anchorperson shot 14 and falsely detects the shot 8 as an anchorperson shot. Therefore, the story unit 41 is almost the same as the hierarchy 1220 in FIG. 12B except for the leading title shot 0. Thus, as was the case with the hierarchy 1230 in FIG. 12C, the user manually edits the hierarchy 1330 using the modeling operations. The resulting hierarchy 1340 is shown in FIG. 13D.

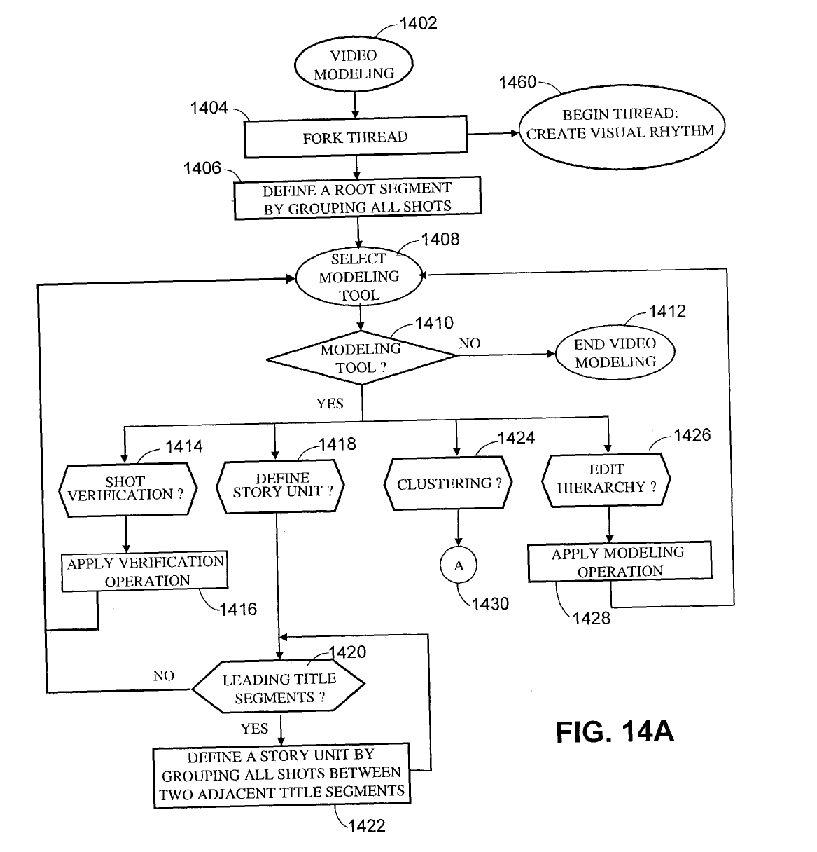

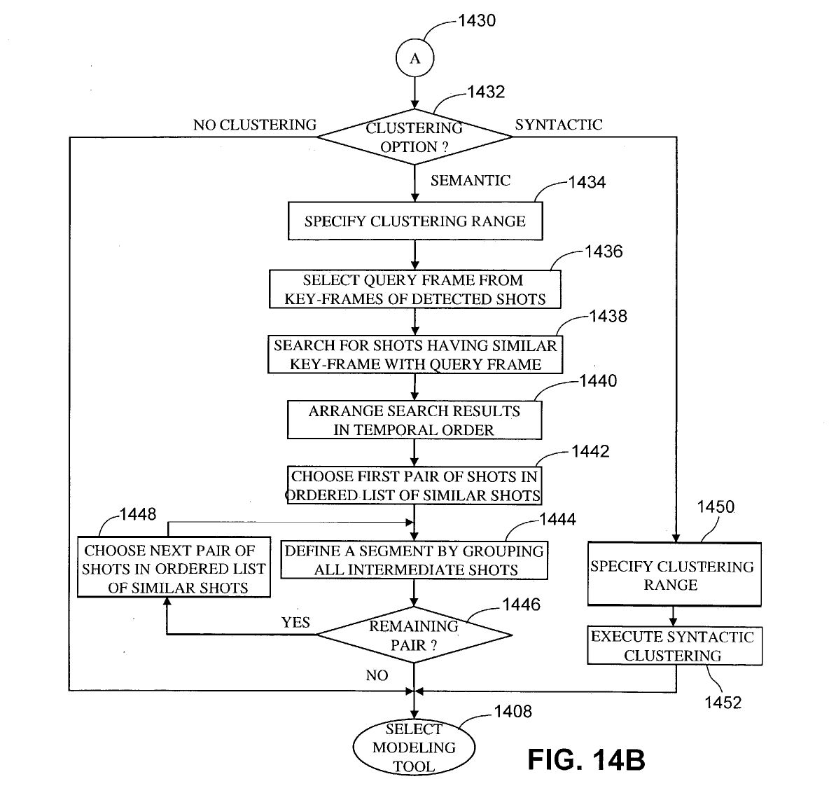

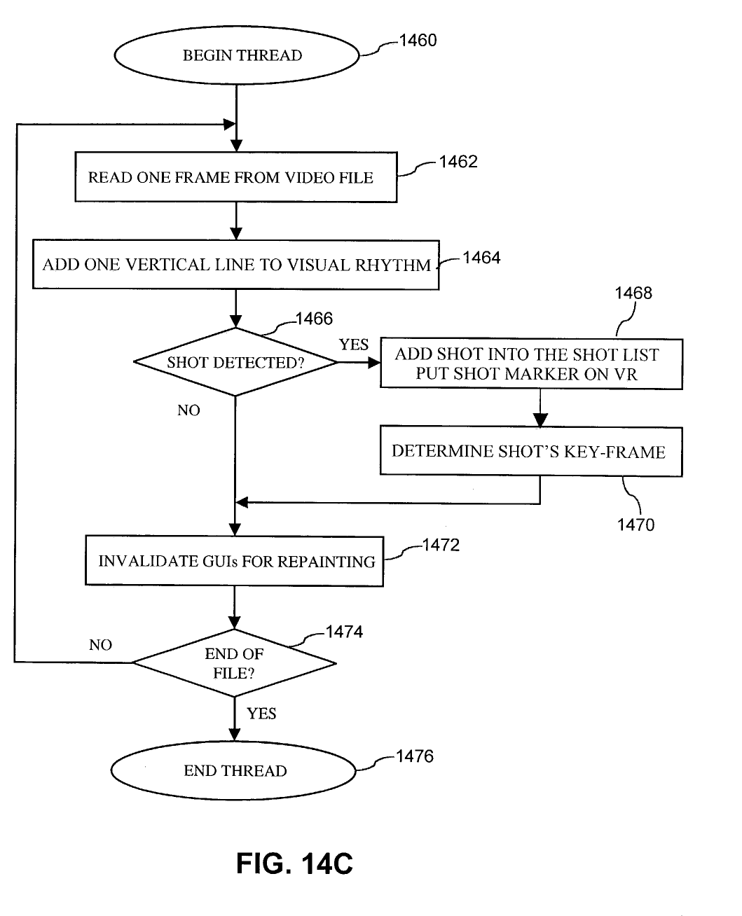

FIGS. 14A, 14B and 14C are flowcharts illustrating an exemplary overall method of constructing a semantic structure for a video, according to the invention.

The content-based video modeling starts at a step 1402. The video modeling process forks to a new thread at step 1404. The new thread 1460 is dedicated to divide a given video stream into shots and select key frames of the detected shots. One embodiment of shot boundary detection and key frame selection is described in detail in FIG. 14C, where visual rhythm generation and shot detection are carried out in parallel. After the shots have been identified, all detected shots are grouped into a single root segment by applying the group operation to all the detected shots in a step 1406. An initial two-level hierarchy, such as was described with respect to FIG. 12A or 13A, is constructed by this grouping.

In a next step 1408, one begins the process of constructing a semantic hierarchy using the initial two-level, by applying a series of modeling tools. In a step 1410, a check is made to determine if a user selects one of the modeling tools: shot verification, defining story unit, clustering, editing hierarchy. If the user wants to finish the construction, the process proceeds to a step 1412 where the video modeling process ends. Otherwise, the user selects one of the modeling tools 1414, 1418, 1424, 1426

If the user wants to verify results of the shot detection in step 1414, the user apply one of the verification operations in step 1416: Set shot marker, Delete shot marker, Delete multiple shot markers. After the application, the control goes back to the select modeling tool process in step 1408.

In the event that a user has a priori knowledge of the input video, the user might know the presence of leading title segments. Also, the user might find out the title segments by human inspection of list of key frames of the detected shots because shots in the title segments usually have text captions in large size. Therefore, if the user wants to define story units in step 1418, a check is made in step 1420 to determine if there are the leading title segments. If so, all shots between two adjacent title segments are grouped into a single segment by manually applying the group operation to the shots in step 1422, and the control then goes to the check in step 1420 again. Otherwise, the control goes back to the select modeling tool process in step 1408.

If the user wants to execute automatic clustering in step 1424, execution of the present invention proceeds to step 1430 of FIG. 14B. By selecting a ‘clustering’ menu item of the ‘tools’ menu in upper-left corner of the GUI screen as shown in FIG. 5, the user is then prompted to choose clustering options in step 1432. Three options are presented: no clustering, syntactic clustering, and semantic clustering.

If the semantic clustering option is chosen, the user is asked to specify the clustering range in step 1434. If the user does not specify the range, the root segment becomes the range by default. Otherwise, the user can select any segment of a current hierarchy, which might be one of story units that are defined in step 1422. The user is once again asked to select a query frame from a list of key frames of the detected shots within the specified clustering range in step 1436. With the query frame, an automatic key frame search method searches for the shots whose key frame is similar to the query frame in step 1438. In step 1440, the resulting shots having key frame similar to the query frame are arranged in temporal order. From the temporally ordered list of similar shots, a pair of the first and second shots is chosen in step 1442. Then, the first shot and all the intermediate shots between the two shots of the pair are grouped into a new segment by applying the group operation to the shots in step 1444. A check is made in step 1446 to determine if next pair of the second and third shots is available in the temporally ordered list of similar shots. If so, the pair is chosen in step 1448 for another grouping in step 1444. If all groupings are performed for existing pairs, the control goes back to the select modeling tool process in step 1408.

If the syntactic clustering option is chosen in the step 1432, the user is also asked to specify the clustering range in step 1450. If the user does not specify the range, the root segment becomes the range by default. Otherwise, the user can select any segment of a current hierarchy. A syntactic clustering algorithm is then executed for the key frames of the detected shots in step 1452, and the control goes back to the select modeling tool process in step 1408.

If the no clustering option is chosen in the step 1432, the control goes back to the select modeling tool process in step 1408. It is noted that, in the semantic clustering, steps 1438, 1440, 1442, 1444, 1446 and 1448 are automatically done, but steps 1434 and 1436 require human intervention.

Returning to FIG. 14A, if the user wants to edit the current hierarchy in step 1426, in the step 1428, the user manually edits the current hierarchy according to his intention by applying one of the modeling operations described hereinabove. After the editing, the control goes back to the select modeling tool process in step 1408. By repeated execution of the steps 1408, 1410, 1426 and 1428, the user can make some proper sequence of the modeling operations. By applying the sequence of modeling operations, the user can construct a semantically more meaningful multi-level hierarchy.

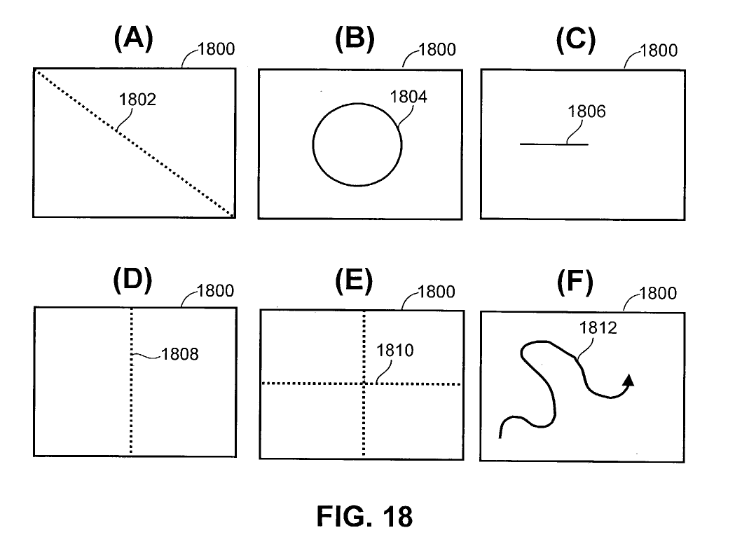

FIG. 14C illustrates the process for creating visual rhythm, which is one of the important features of the present invention. Ideally, this process is spawned as a separate thread in order not to block other operations during the creation. The thread starts at step 1460 and moves to a step 1462 to read one video frame into an internal buffer. The thread generates one line of visual rhythm at step 1464 by extracting the pixels along the predefined path (e.g., diagonal, from upper left to lower right, see FIG. 18A) across the video frame and appending the extracted slice of pixels to the existing visual rhythm. At a step 1466, a check is made to decide if a shot boundary occurs on the current frame. If so, then the thread proceeds to a step 1468 where the detected shot is saved into the global list of shots and a shot marker (e.g., 822) is inserted on the visual rhythm, followed by a step 1470 where the current frame is chosen as the representative key frame of the shot (by default), and followed by a step 1472 where any GUI objects altered by this visual rhythm creation process are invalidated to be redrawn some time soon in the near future. If the check at the step 1466 fails, the thread goes directly to the step 1472. At a step 1474, another check is made whether to reach the end of the input file. If so, the thread completes at a step 1476. Otherwise, the thread loops back to the step 1462 to read the next frame of the input video file.

The overall method in FIGS. 14A, 14B and 14C works with the GUI screen shown in FIG. 5. Using the method, there is no single shortest and best way to complete the construction of the hierarchical representation of the video, because which modeling tool with its corresponding GUI component should be used first may vary depending on the situations. Generally, however, the GUI components in FIG. 5 may often be used as follows:

1. With the GUI for the view of visual rhythm: Look over (inspect) the visual rhythm to ascertain if there are false positive (falsely detected) shots or false negative (undetected) shots. To facilitate this shot verification process, the four control buttons 830 of FIG. 8 are provided to move the visual rhythm fast forward and backward, and to zoom in and zoom out the visual rhythm.

2. With the GUI for the list view of key frame search: If the semantic clustering does not lead to the well-defined semantic hierarchy, the “Search” control button 551 of FIG. 5 can be triggered as many times as possible with different threshold values until most of similar frames are retrieved.

3. With the GUI for the list view of a current segment: Look deeper into the key frames and see if the current hierarchy made so far represents well the content of the video. If not, use the modeling operations 527 of FIG. 5 such as group, ungroup, merge and split to transform the hierarchy until the desirable one is constructed. Diverse playback functions are also employed to scrutinize the semantic continuity among the multiple segments.

4. With the GUI for the tree view of a video: Look over the tree view to specify a clustering range for the automatic clusterings. Also, add a textual description to segments in the tree view.

It should be noted that, in FIGS. 14A and 14B, only steps 1416, 1420 and 1422, 1428, 1432, 1434, 1436 and 1450 require human intervention. The other steps are executed automatically by suitable automated algorithms or methods. For example, there exist many techniques for shot boundary detection and key frame selection methods for step 1404, content-based key frame search methods for step 1438, content-based syntactic clustering methods for step 1452. Also, at the end of video modeling in step 1412, the structure of the current hierarchy as well as key frames, text annotations and other metadata information are saved into a file according to a predetermined format such as MPEG-7 MDS (Metadata Description Scheme) or TV Anytime metadata format.

With the list of detected shots in step 1404, the overall method in FIGS. 14A and 14B can be performed full-automatically, semi-automatically, or even fully manually. For example, if only syntactic clustering is performed, it is fully automatic. If the user edits the hierarchy only with the modeling operations, it is fully manual. Also, if the manual editing follows after the syntactic or semantic clustering, it is semi-automatic. The method of the present invention further allows that the syntactic or semantic clustering can follow after the manual definition of story unit or any manual editing. That is, the method of the present invention allows that any of the modeling tools can be interleaved, thus giving a great flexibility of constructing the semantic hierarchy.

4. Extensible Features

Use of Templates

It is not uncommon to find videos whose story format has some fixed (regular) structure. For instance, a 30-minute long CNN news video may have “Top stories” at 1 minutes from the beginning, “Life and style” at 15 minutes, “Sports” at 25 minutes, etc. “Sesame Street”, an educational TV program for children, also tends to have a regular content structure: a part for today's topics, followed by a part for learning numerals, and followed by a part for learning alphabets, and so on. For these kinds of videos, if the prior (a priori) knowledge or the outcome derived from indexing the video for the first time is carefully used, the efforts for the second indexing can be greatly reduced. These kinds of prior knowledge and indexing results, for example, the TOC (Table-of-Contents) tree as shown in FIG. 6, are referred to as “templates” herein, and these templates can be saved into a persistent storage at the first-time indexing so that they can be loaded into the memory and used at any time they are needed.

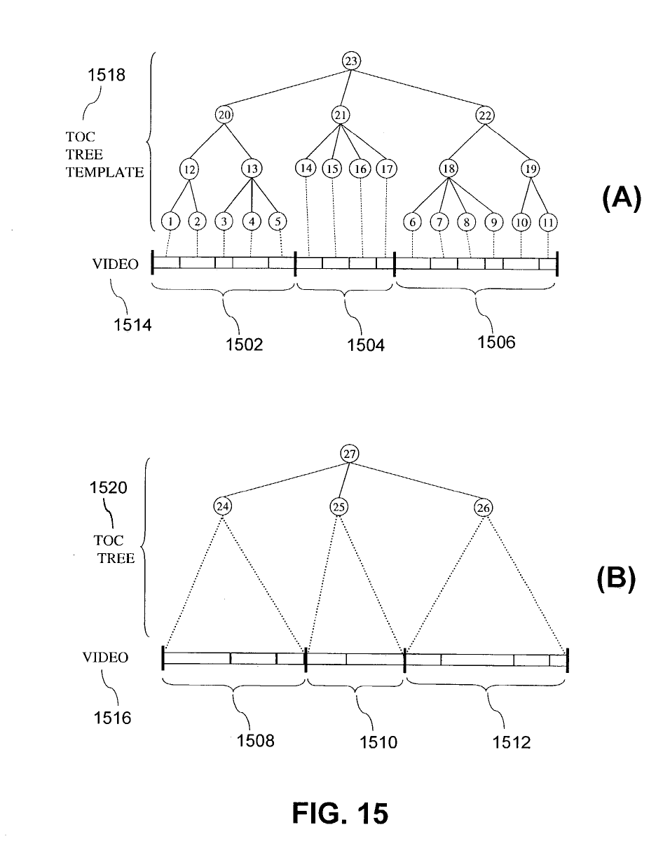

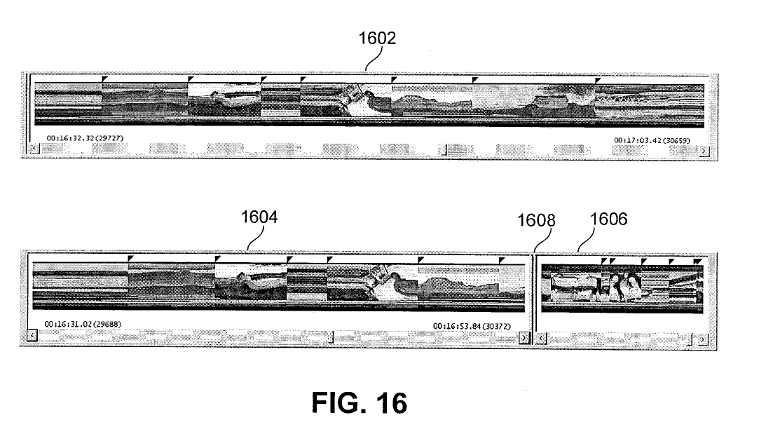

FIGS. 15(A) and (B) illustrate the use of a TOC tree template to build a TOC tree for another video quickly and reliably. The tree 1518 represents a template for the description tree (also called TOC tree) of a reference video 1514. If the reference video is CNN news, the first segment represented by 1502 may tell about, for example, “Top Stories”, the second segment 1504 covering “Life and Style”, and the last segment 1506 covering “Sports”. In view of the template tree, the root node labeled 23 represents the CNN news program 1514 in its entirety. Each tree node 20, 21, and 22 corresponds to the segment 1502, 1504, and 1506, respectively. The total number of leaf nodes derived from the tree node 20 is five, which is equal to the total number of shots included in the segment 1502. The same relationship holds between the node 21 and the segment 1504, as well as between the node 22 and the segment 1506.

The TOC tree template 1518 may readily be utilized to construct a TOC tree 1520 for another CNN news program (current video) 1516 which is similar to the reference news program (reference video) 1514, since it can easily be inferred from the template 1518 that the current CNN news program 1516 should be also composed of three subjects. Thus, the video 1516 is carefully divided (parsed, segmented) into three video segments 1508, 1510, and 1512 such that the length (duration) of each segment in it is commensurate with the length of the corresponding segment in the TOC tree template 1518. The result of the segmentation is reflected into the TOC tree 1520 by creating three child nodes 24, 25, and 26 under the root node 27. Thus, the nodes 24, 25, and 26 cover the segments 1508, 1510, and 1512, respectively. Note, however, that the number of shots in each segment in the video 1516 doesn't need to be equal to the number of shots in the corresponding segment in the video 1514.

Likewise, the process of template-based segmentation can be repeated at the next lower levels, depending on the extent of depth to which the TOC template is semantically meaningful. For example, if the nodes 12 and 13 in the template 1518 are determined to be semantically meaningful nodes again, then the segment 1508 can be further divided into two sub-segments so that the tree node 24 may have two child nodes. Otherwise, other syntactic based clustering methods using low-level image features can be applied to the segment 1508.

One aspect of using the TOC tree templates is to predict the “shape” of other TOC trees as described above. In addition, another aspect is to alleviate the efforts to type in descriptions associated with video segments. For example, if a detailed description is needed for the newly created node 24, the existing description of the corresponding node 20 in the template 1518 can be copy-and-pasted into the node 24 with a simple drag-and-drop operation and may be edited a little, if necessary, for correct description. Without the benefit of having existing annotations in the template, however, one would need to enter the description into each and every node of the TOC tree (1520). It will be more efficient to utilize TOC as well as video matching for a sequence of frames representing the beginning of each story unit if available.

Visual Rhythm Behaves as a Progress Bar

One of the common GUI objects widely used in a visual programming environment such as Microsoft Visual C++ is a “progress bar”, which indicates the progress of a lengthy operation by displaying a colored bar, typically from left-to-right, as the operation makes the progress. The length of the bar (or of a distinctively colored segment which is ‘growing’ within an outline of the overall bar) represents the percentage of the operation that has been complete. The generation of visual rhythm may be considered to be such a “lengthy operation” and generally takes as much time as the running time of a video. Therefore, for a one-hour video, a progress bar would fill commensurately slowly with the lapse of the time.

According to an aspect of the invention, the visual rhythm image is used as a “special progress bar” in the sense that as one vertical line of visual rhythm is acquired during the visual rhythm creation process, it is appended into the end of (typically to the right hand end of) the ongoing visual rhythm, thereby gradually showing the progress of the creation with visual patterns, not a simple dull color.

The gradual display of visual rhythm creation benefits the present invention in many ways. When using the traditional progress bar, one would need to wait for the completion of visual rhythm creation, doing nothing. On the contrary, the visual rhythm progress bar keeps delivering some useful information to continue indexing operations. For example, one can inspect the partially generated visual rhythm to verify the shots detected automatically by a shot detection method. During the generation of visual rhythm, the falsely detected shots or missing shots can be corrected through this verification process.

Another aspect of the present invention is to show the detected shots gradually as the time passes. There are broadly two classes of automatic shot detection methods. One is to read an input video in full, and detect and produce the resulting shots at the completion of the reading. The other one reads in one video frame at a time and makes a decision over the occurrence of a shot boundary at each read-in frame. The present invention preferably uses the latter progressive approach (e.g., FIG. 14C) to show the progress of visual rhythm creation and the progress of detected shots in parallel.

Splitting of Visual Rhythm

FIG. 16 illustrates the splitting of the view of visual rhythm. The original view 1602 of visual rhythm is shown on the top of the figure, and can be split into any number (a plurality, two or more) of windows. In this example, the visual rhythm image 1602 is split into two small windows 1604 and 1606 as shown on the bottom of the figure. The relative length of the split windows 1604 and 1606 can be adjusted by sliding the separator bar 1608 along the horizon (towards either the beginning or end of the overall visual rhythm image). This window splitting provides a way to inspect different portions of visual rhythm simultaneously, thereby carrying out multiple operations. For example, the right window 1606 may be used to keep monitoring the progress of the automatic shot detection whereas the left window 1604 may be used to perform other operations like the “Set shot marker” or “Delete shot marker” of the manual shot verification operations. As mentioned before, the shot verification is a process to check whether a detected shot is really a true shot or whether there are any missing shots. Since the visual rhythm contains distinct and discernible patterns for shot boundaries (typically, a vertical line for a cut, and an oblique line for a wipe), one can easily check the validity of shots by glancing at those patterns. In other words, each of the split windows can be utilized to assist in the performance of different editing tasks.

Visual Rhythm for a Large File

As the running time of a video gets longer, the memory needed to store the visual rhythm increases proportionally. Assuming a one-hour ASF video requires around 10 MB of memory for visual rhythm, the memory space necessary to process a one-day broadcast video footage would be 240 MB. This figure for much longer video footages soon exceeds the total memory space retained by an underlying indexing system while being displayed in the view of visual rhythm 530 of FIG. 5. Therefore, the present invention addresses this problem and discloses a simple method to alleviate such an exorbitant memory requirement.

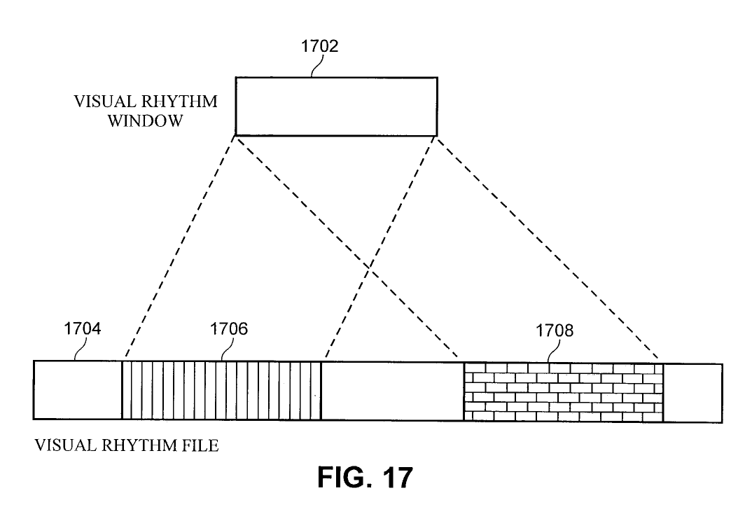

FIG. 17 schematically illustrates a technique for handling the memory exceeding problem of lengthy visual rhythm while displaying it in the view of visual rhythm. Basically, the visual rhythm being generated is not directed into the memory—rather, it is directed to a dedicated file 1704. As each vertical element of visual rhythm is generated, it will be appended into the dedicated file. Eventually, with the lapse of time, the size of the dedicated file will grow beyond the width of the view of visual rhythm window 1702. Since it is usually sufficient to view only a portion of visual rhythm at a time, the actual amount of memory necessary for displaying visual rhythm is not the size of the entire file, but a constant that is equivalent to the area occupied by the view of visual rhythm window 1702.

By providing the fixed-width window 1702, it is easy to make a random access to any portions of visual rhythm. Consider that a portion of the visual rhythm 1706 is currently shown in the view 1702 of visual rhythm. Then, the view of visual rhythm, when receiving the request to show a new portion 1708, will switch its contents by first seeking the place in the file where new portion is located, loading the new portion and finally replacing the current portion with the new one.

Visual Rhythm: Sampling Pattern

Each vertical slice of visual rhythm with a single pixel width is obtained from each frame by sampling a subset of pixels along a predefined path. FIG. 18 (A-F) shows some examples of various sampling paths drawn over a video frame 1800. FIG. 18A shows a diagonal sampling path 1802, from top left to lower right, which is generally preferred for implementing the techniques of the present invention. It has been found to produce reasonably good indexing results, without much computing burden. However, for some videos, other sampling paths may produce better results. This would typically be determined empirically. Examples of such other sampling paths 1804, 1806, 1808, 1810 and 1812 are shown in FIGS. 18B-F, respectively.

The sampling paths may be continuous (e.g., 1804 and 1806) where all pixels along the paths are sampled, discrete/discontinuous (1802, 1808 and 1810) where only some of the pixels along the paths are sampled, or a combination of both. Also, the sampling paths may be simple (e.g., 1802, 1804, 1806 and 1808) where only a single path is used, composite (e.g., 1810) where two or more paths are used. In general, the sampling path can be any 2D continuous or discrete curves as shown in 1812 (simple sampling path) or any combination of the curves (composite sampling path).

According to the invention, a set of frequently used sampling paths is provided in the form of templates, plus a GUI upon which the user can draw a user-specific path with convenient line drawing tools similar to the ones within Microsoft (tm) PowerPoint (tm).

Fast Display of a Plethora of Key frames

Understandably, the number of key frames reaches its peak soon after the completion of shot detection. That peak number is often in the order of hundreds to tens of thousands, depending on the contents or length of the video being indexed. However, it is not trivial to fast display such a large number of key frame images in the list view of a current segment 520 of FIG. 5.

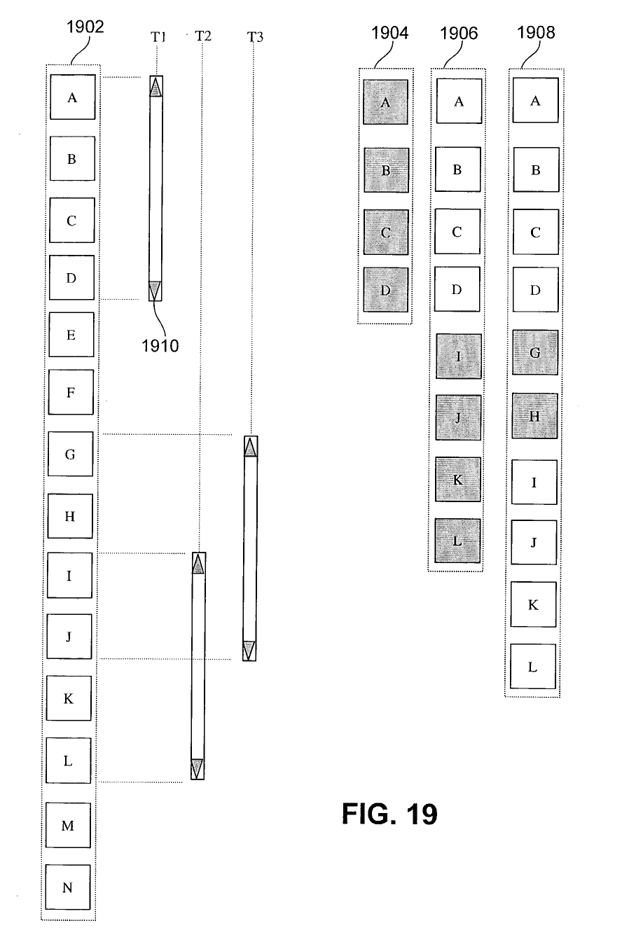

FIG. 19 illustrates an agile way to display a plethora (large number) of images quickly and efficiently in the list view of a current segment. Assume that the list 1902 represents the list (set) of all the logical images to be displayed. The goal is to build the list of physical images rapidly using information on logical images without causing any significant delays in image display. One major reason for the delay lies in an attempt to obtain the complete list of physical images from the outset.

According to the invention, a partial list of physical frames is built in an incremental manner. For example, the scrollbar 1910 covers the four logical images labeled A, B, C, and D at time T1. Thus, only those four images are registered into the physical list and those images are shown on the screen immediately, although the physical list has not been completed. The partially constructed physical list will be shown like 1904. Similarly, at time T2, the scrollbar spans (ranges) over four new images (I, J, K, and L), which are registered into the physical list. The physical list now grows to 8 images as shown in 1906. Lastly, at time T3, the scrollbar ranges over four images (G, H, I, and J), where images I and J have already been registered and images G and H are newcomers. Therefore, the physical list accepts only the newly-acquired images G and H into it. After the three scrolling actions, the physical list now contains 10 images as shown in 1908. As more scrolling actions are activated, the partial list of physical frames gets filled with more images.

Tracking of the Currently Playing Frame

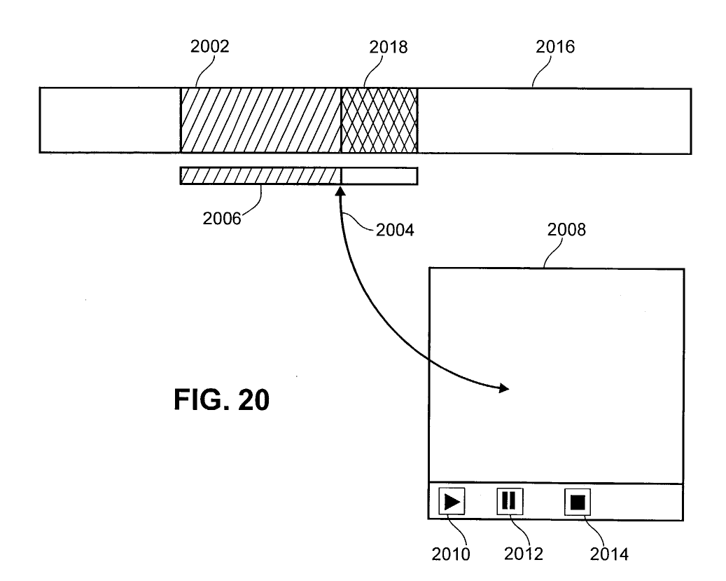

It is sometimes observed that a video segment that is homogeneous (relatively unchanging) in terms of visual features (colors, textures, etc.) can convey semantically different subjects, one after the other. For example, a participant in video conferencing session can change the topic of conversation (different semantic unit) while his face still appears, relatively unchanged, on the screen. In such instances, it is not practical to accurately locate the point of subject changes without listening to the speech of the participant. FIG. 20 illustrates a technique for handling such situations, which is the tracking of the current frame while the video is playing, in order to manually make a new shot from the starting point of the subject change.

Assume that the video player 2008 (compare 330) is loaded along with the video segment 2002 specified on the view of visual rhythm 2016. The player has three conventional controls: playback 2010, pause 2012, and stop 2014. If the playback button 2010 is clicked, then the “tracking bar” 2006 will appear under the visual rhythm 2016 and its length will grow from left-to-right as the playback continues. During the playback, the user can click the pause button 2012 at any moments when he determines that a different semantic unit (topics or subjects) gets started. In response to the pause click, the tracking bar 2006 as well as the player comes to a halt at a certain point 2004 in the track. Then, the frame 2018 corresponding to the halted position 2004 can be inspected to decide whether a new shot would be present around this frame. If it decided to designate a new shot, the user sets a new shot starting with the frame 2018 by applying the “Set shot marker” operation manually. Otherwise, the user repeats the cycle of “playback and pause” to find the exact location of semantic discontinuity.

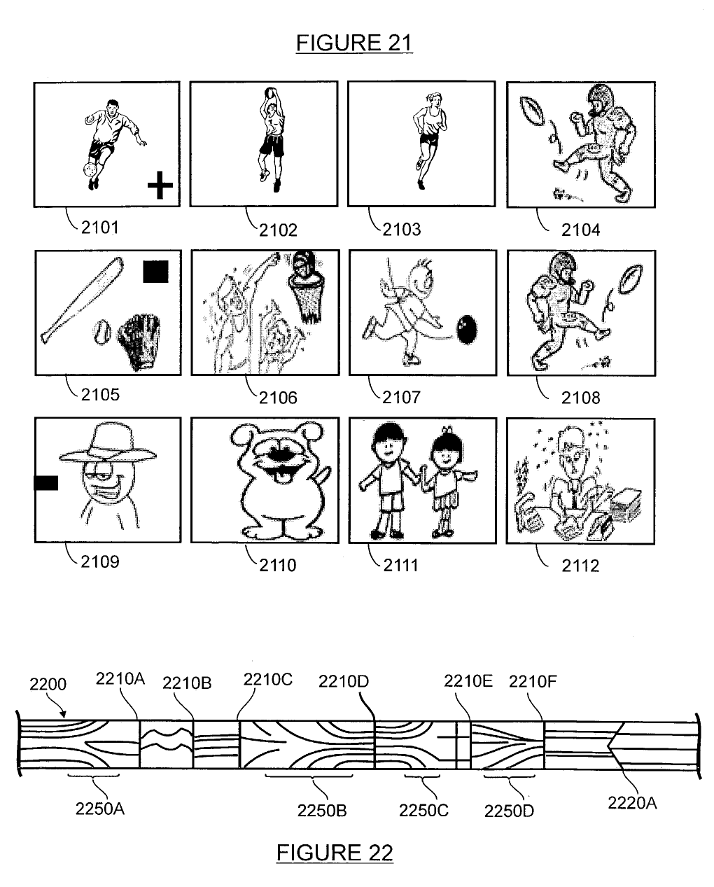

In various figures of this patent application, small pictures may be used to represent thumbnails, key frame images, live broadcasts, and the like. FIG. 21 is a collection of line drawing images 2101, 2102, 2103, 2104, 2105, 2106, 2107, 2108, 2109, 2110, 2111, 2112 which may be substituted for the small pictures used in any of the preceding figures. Generally, any one of the line drawings may be substituted for any one of the small pictures. Of course, if two adjacent images are supposed to be different than one another, to illustrate a point (such as key frames for two different scenes), then two different line drawings should be substituted for the two small pictures.

FIG. 22 is a diagram showing a portion 2200 of a visual rhythm image. Each vertical line (slice) in the visual rhythm image is generated from a frame of the video, as described above. As the video is sampled, the image is constructed, line-by-line, from left to right. Distinctive patterns in the visual rhythm image indicate certain specific types of video effects. In FIG. 22, straight vertical line discontinuities 2210A, 2210B, 2210C, 2210D, 2210E, 2210F, indicate “cuts” where a sudden change occurs between two scenes (e.g., a change of camera perspective). Wedge-shaped discontinuities 2220A and diagonal line discontinuities (not shown) indicate various types of “wipes” (e.g., a change of scene where the change is swept across the screen in any of a variety of directions). Other types of effects that are readily detected from a visual rhythm image are “fades” which are discernable as gradual transitions to and from a solid color, “dissolves” which are discernable as gradual transitions from one vertical pattern to another, “zoom in” which manifests itself as an outward sweeping pattern (two given image points in a vertical slice becoming farther apart) 2250A and 2250C, and “zoom out” which manifests itself as an inward sweeping pattern (two given image points in a vertical slice becoming closer together) 2250B and 2250D.

Although the invention has been illustrated and described in detail in the drawings and foregoing description, the same is to be considered as illustrative and not restrictive in character—it being understood that only preferred embodiments have been shown and described, and that all changes and modifications are desired to be protected.

What is claimed is:

1. A method of constructing and/or browsing a hierarchical representation of a content of a video, comprising:
providing a content hierarchy module representing relationships between segments, sub-segments and shots of a video;
providing a visual content of a segment of current interest module representing visual information for a selected segment within the hierarchy;
providing a visual overview of a sequential content structure module;
providing a unified interaction module for coordinating the function of the content hierarchy module, the visual content of a segment module, and the visual overview of a sequential content structure module, and propagating any request of a module to others; and
providing a graphical user interface (GUI) screen for simultaneously showing the content hierarchy module, the visual content of a segment module, and the visual overview of a sequential content structure module.

2. Method, according to claim 1, wherein the content hierarchy module comprises a tree view of a video, and further comprising:
displaying a root segment and any number of its child and grandchild segments in the tree view of a video;
selecting a current segment in the tree view and adding a short textual explanation to each segment;
associating a metadata description with each segment, said metadata description comprising at least one of the title, start time and duration of the segment; and
associating a key frame image with the segment.

3. Method, according to claim 2, wherein a selected one of the key frames for the sub-segments is selected as the key frame for the current segment.

4. Method, according to claim 2, further comprising:
providing a symbol on the key frames for the sub-segments indicating whether:
the key frame has been selected as the key frame for the current segment; and
the sub-segment associated with the key frame has some number of its own sub-segments.

5. Method, according to claim 1, wherein the visual content of a segment (sub-hierarchy) of current interest module comprises a list view of a current segment, and further comprising:
displaying key frame images each of which represents a sub-segment of the current segment in the list view;
displaying at least two types of key frames in the list view, a first type being a plain key frame indicating to the user that the associated sub-segment has no further sub-segments and a second type being a marked key frame indicating to the user that that the associated sub-segment is further subdivided into sub-sub-segments;
in response to the user selecting a marked key frame, the selected marked key frame becomes the current segment key frame, its metadata is displayed, and key frame images for its associated sub-segments are displayed in the list view; and
providing a set of buttons for modeling operations, said modeling operations comprising at least one of group, ungroup, merge, split, and change key frame.

6. Method, according to claim 1, wherein the visual overview of a sequential content structure module comprises a visual rhythm of the video, and further comprising:
displaying at least a portion of the visual rhythm;
providing a shot marker at each shot boundary, adjacent the visual rhythm;
navigating through the visual rhythm display by forwarding or reversing to display another portion of the visual rhythm; and
controlling the horizontal scale factor of the visual rhythm display by adjusting the time resolution of the portion of the visual rhythm being displayed.

7. Method, according to claim 6, wherein the portion of the visual rhythm being displayed in the view of visual rhythm is a virtual representation of the visual rhythm.

8. Method, according to claim 6, wherein the visual overview of a sequential content structure module comprises a visual rhythm of the video, and further comprising:
displaying at least a portion of the visual rhythm; and
displaying an audio waveform displayed in parallel with, and synchronized to, the visual rhythm display according to time line by adjusting the time scale of the visual rhythm.

9. Method, according to claims 6, further comprising:
synchronizing the audio waveform with the visual rhythm by adding extra lines into or dropping selected lines from the visual rhythm

10. Method, according to claim 9, further comprising:
providing a simplified representation of the hierarchical tree structure emphasizing the relative durations and temporal positions of the segments that lie in the path from a root segment to a current segment with multiple bar segments;
wherein each bar segment has a length corresponding to the relative duration of the corresponding video segment, and each bar segment being visually distinct from adjacent bar segments;
displaying information about the temporal and hierarchical locations of a selected video segment;
navigating the video hierarchy to locate specific video segments or shots of interest;
in response to selecting a position along the hierarchical status bar, highlighting the video segment associated with that position in both the tree view and visual rhythm view; and
providing user information on the nested relationships, relative durations, and relative positions of related video segments, graphically.

11. A graphical user interface (GUI) for constructing and/or browsing a hierarchical representation of a content of a video, comprising:
means for showing a status of a content hierarchy, by which a user is able to see a current graphical tree structure the hierarchical representation being built, and to visually check the content of a video segment of current interest as well as the contents of the segment's sub-segments;
means for showing the status of the video segment of current interest;
means for showing the status of a visual overview of a sequential content structure, including a visual pattern of the sequential structure, for providing both shot contents and positional information of shot boundaries, and for providing time scale information implicitly through the widths of the visual pattern, and for quickly verifying the video content, segment-by-segment, without repeatedly playing each video segment, and for finding a specific part of interest or identifying separate semantic units in order to define the video segments and their sub-segments by quickly skimming through the video content without playback;
means for displaying a visual representation of a nested relationship of the video segments and their relative temporal positions and durations, and for providing the user with an intuitive representation of a nested structure and related temporal information of the video segments; and
means for displaying results of a content-based key frame search.

12. A GUI, according to claim 11, wherein the list view of a current segment comprises interfaces for the modeling operations to manipulate the hierarchical structure of the video content, and further comprising:
before performing one of the modeling operations, selecting input segments from the list of key frames representing the sub-segments of the current segment in the list view of a current segment; and
invoking the modeling operation by clicking on one of the corresponding control buttons for the modeling operation;
wherein the modeling operations involve:
in the group operation, taking a set of sibling nodes as an input, creating a new node and inserting it as a child node of the siblings' parent node, and making the new node parent to the sibling segments which are grouped;
in the ungroup operation, removing a node and making its child nodes child to its parent node;
in the merge operation, given a set of adjacent sibling nodes as an input, creating a new node that a child node of the siblings' parent node, then making the new node parent to all the child nodes under the sibling nodes;
in the split operation, taking a node whose children can be divided into two disjoint sets of child nodes and decomposing the node into two new nodes, each of which has a portion of child segments as its child segments; and
in the change key frame operation, for a given segment, replacing the key frame of the parent of the given segment with the key frame of the given segment;
wherein the parent, child and sibling nodes represent segments or sub-segments in the hierarchical structure of the video content.

13. A GUI, according to claim 11, wherein the view of visual rhythm comprises interfaces for the shot verification/validation operations, and further comprising:
designating shot boundaries by locating a shot marker at each boundary, adjacent the visual rhythm;
providing a cursor on the visual rhythm that points to a specific frame or point of current interest for applying the Set shot marker operation; and
specifying a single shot marker or multiple successive shot markers for applying the delete shot marker or delete multiple shot markers operations;
wherein the shot verification/validation operations involve:
in the set shot marker operation for manually dividing a shot into two adjacent shots by placing a new shot marker at a corresponding point along the visual rhythm;
in the delete shot marker operation for manually combining two adjacent shots into a single shot by deleting a designated shot marker between the two shots at corresponding point along the visual rhythm; and
in the delete multiple shot markers operation for manually combining more than three adjacent shots into a single shot by deleting successive designated shot markers between the shots at corresponding points along the visual rhythm.

14. A GUI, according to claim 11, wherein the list view of key frame search comprises interfaces for the semantic clustering, and further comprising:
adjusting a similarity threshold value for another content-based key frame search by clicking on a slide bar of the value;
triggering the search by clicking on a corresponding control button;
performing the re-adjusting and re-triggering the search as many times as a user gets a desired search result;
triggering iterative groupings by clicking on a corresponding control button;
wherein the semantic clustering involves:
in specifying a clustering range by selecting any segment in a current hierarchy being constructed;
in selecting a recurring shot that occurs repetitively from a list of shots of a video within the clustering range;
in using a key frame of the selected shot as a query frame, performing a content-based image search in the list of shots within the specified clustering range in order to search for all recurring shots whose key frames exhibit visual similarities to the query frame;
in listing the retrieved recurring shots in temporal order; and
with the temporally ordered list of the retrieved recurring shots, replacing a current sub-hierarchy of the selected segment with a new semantic hierarchy by iteratively grouping intermediate shots between each pair of two adjacent recurring shots into a single sub-segment of the selected segment.

15. A method for constructing or editing a hierarchical representation of a content of a video, said video comprising a plurality of shots, comprising:
providing automatic semantic clustering;
providing manual modeling operations;
providing manual shot verification/validation operations; and
interleaving the manual and automatic methods in any order, and applying them as many times as a user wants.

16. Method, according to claim 15, said semantic clustering further comprising:
specifying a clustering range by selecting any segment in a current hierarchy being constructed;
selecting a recurring shot that occurs repetitively from a list of shots of a video within the clustering range;
using a key frame of the selected shot as a query frame, performing a content-based image search in the list of shots within the specified clustering range in order to search for all recurring shots whose key frames exhibit visual similarities to the query frame;
listing the retrieved recurring shots in temporal order; and
with the temporally ordered list of the retrieved recurring shots, replacing a current sub-hierarchy of the selected segment with a new semantic hierarchy by iteratively grouping intermediate shots between each pair of two adjacent recurring shots into a single sub-segment of the selected segment.

17. Method, according to claim 16, further comprising:
adjusting a similarity threshold value for the search.

18. Method, according to claim 16, further comprising:
replacing a current sub-hierarchy of the selected segment with a new semantic hierarchy by iteratively grouping intermediate shots between pairs of adjacent detected shots into a single segment.

19. Method, according to claim 16, further comprising:
if the semantic clustering does not lead to a well-defined semantic hierarchy, triggering the search operation with different similarity threshold values until most of similar key frames are retrieved.

20. Method, according to claim 16 further comprising:
looking deeper into the key frames to see if the current hierarchy made so far reflects well the content of the video and, if not, using modeling operations to transform the hierarchy until the desirable one is constructed.

21. Method, according to claim 16, said modeling operations further comprising:
in the group operation, taking a set of sibling nodes as an input, creating a new node and inserting it as a child node of the siblings' parent node, and making the new node parent to the sibling segments which are grouped;
in the ungroup operation, removing a node and making its child nodes child to its parent node;
in the merge operation, given a set of adjacent sibling nodes as an input, creating a new node that a child node of the siblings' parent node, then making the new node parent to all the child nodes under the sibling nodes;
in the split operation, taking a node whose children can be divided into two disjoint sets of child nodes and decomposing the node into two new nodes, each of which has a portion of child segments as its child segments; and
in the change key frame operation, for a given segment, replacing the key frame of the parent of the given segment with the key frame of the given segment;
wherein the parent, child and sibling nodes represent segments or sub-segments in the hierarchical structure of the video content.

22. Method, according to claim 15, further comprising:
selecting a clustering range which is a portion of the entire video, said clustering range comprising one or more segments of the video;
repetitively grouping visually similar consecutive shots based on the similarities of their key frames by a request of a user; and
if recurring shots are present, repetitively grouping consecutive shots between each pair of two adjacent recurring shots by a request of a user.

23. Method, according to claim 15, wherein there already exists a table of contents (TOC) tree for a reference video, comprising:
performing template-based segmentation on a current video using the TOC template from the reference video to construct a TOC tree for the current video; and
repeating the process of template-based segmentation at lower levels of the hierarchy.

24. Method, according to claim 15, said shot verification/validation operations further comprising:
in the set shot marker operation, taking a shot as an input, dividing the shot into two adjacent shots;
the delete shot marker operation, taking a set of two adjacent shots as an inputs, combining the two shots into a single shot; and
the delete multiple shot markers operation, taking a set of more than three adjacent shots as an inputs, combining the shots into a single shot.

25. Method, according to claim 15, wherein the video comprises a plurality of story units each of which has leading title shots and their own recurring shots, further comprising:
detecting shots and automatically generating an initial two-level hierarchy structure of all the shots grouped as nodes under a root node, each shot having a key frame associated therewith;
identifying story units with their leading title shots;
performing the group modeling operation for each identified story unit starting with the title shot, to create a new hierarchy structure having a third level of nodes between the nodes and the root node; and
executing semantic clustering using one of the recurring shots as a query frame for each grouped story unit.

26. Method, according to claim 15, further comprising:
dividing the video stream into shots and selecting key frames of the detected shots;
grouping the detected shots into a single root segment, resulting in an initial two-level hierarchy; and
repeatedly performing at least one of modeling processes comprising shot verification, defining story unit, clustering, editing hierarchy.

27. Method, according to claim 26, wherein the modeling processes involve:
in the shot verification process, performing at least one of the following operations: set shot marker, delete shot marker, delete multiple shot markers,
in the defining story unit process, checking to determine if there are the leading title segments and, if so, grouping all shots between two adjacent title segments into a single segment by manually applying the group operation to the shots,
in the clustering process, choosing between performing no clustering, performing semantic clustering and performing syntactic clustering; and
in the editing hierarchy process, the user manually edits the current hierarchy with one of the following operations: group, ungroup, merge, split, change key frame.
